(19) United States
(12) Patent Application Publication
(10) Pub. No.: US 2026/0357365 A1
(43) Pub. Date: Nov. 12, 2026

(54) NON-ORIENTED ELECTRICAL STEEL SHEET AND PRODUCTION METHOD THEREOF

(71) Applicant: JFE STEEL CORPORATION, Tokyo (JP)

(72) Inventors: Yoshiaki ZAIZEN, Tokyo (JP); Tomoyuki OKUBO, Tokyo (JP); Hayato SAITO, Tokyo (JP); Takaaki TANAKA, Tokyo (JP); Ryuichi SUEHIRO, Tokyo (JP)

(73) Assignee: JFE STEEL CORPORATION, Tokyo (JP)

(21) Appl. No.: 19/125,132

(22) PCT Filed: Aug. 31, 2023
(86) PCT No.: PCT/JP2023/031961

§ 371 Date: Apr. 28, 2025

(30) Foreign Application Priority Data
Oct. 31, 2022 (JP) 2022-174748

(51) Int. Cl. C21D 9/46; C21D 8/1216; C21D 8/1244; C21D 8/1277; C22C 38/00; C22C 38/02; C22C 38/04; C22C 38/06; C22C 38/10; C25F 1/00

(52) U.S. Cl. CPC C21D 9/46; C21D 8/1222; C21D 8/1233; C21D 8/1272; C21D 8/1277; C22C 38/002; C22C 38/02; C22C 38/04; C22C 38/06; C22C 38/10; C25F 1/00

(57) ABSTRACT

A non-oriented electrical steel sheet with a low iron loss in a high magnetic-flux-density region that does not cause a decrease in the magnetic flux density or a decrease in the productivity, and proposes an advantageous production method thereof. The non-oriented electrical steel sheet has an ingredient composition containing C, Si, Mn, P, S, Al, N, Co, Ti, Nb, and O, and has an oxide layer containing Si, Al, and Co on a surface of the steel sheet on at least one side. The production method of the non-oriented electrical steel sheet includes the steps of subjecting a steel slab to hot rolling, annealing or no annealing, cold rolling, electrolytic degreasing treatment, and finishing annealing. In the electrolytic degreasing treatment, the charge density, the concentration, the liquid temperature, and the treatment time of an alkali liquid are specified. In the finishing annealing, a low dew point is set.

### TECHNICAL FIELD

The present invention relates to a non-oriented electrical steel sheet with excellent magnetic properties and a production method thereof.

### BACKGROUND ART

In recent years, environmental concerns, such as global warming, have been creating the need for saving energy. The automotive sector has been advancing the development of hybrid electric vehicles (HEVs) that use an engine and a motor in combination, all-electric vehicles (EVs) that are driven by an electric motor alone, fuel-cell electric vehicles (FCEVs), etc. As to the aforementioned motor, the efficiency and the output of such a motor have been becoming increasingly higher, and there is a growing demand for a higher motor output for motors of EVs that do not have an internal combustion engine, such as an engine. As iron core materials of such driving motors of EVs, non-oriented electrical steel sheets are often used. To achieve a higher output and higher efficiency of motors, these steel sheets are strongly required to reduce their iron loss in a high magnetic-flux-density region.

Conventional approaches to reducing the iron loss of non-oriented electrical steel sheets include adding alloy elements, mainly Si, Al, etc. to enhance the specific resistance, and reducing the sheet thickness to reduce the eddy-current loss. However, adding a large amount of alloy elements, while it can achieve a reduction of the iron loss, leads to a decrease in the saturated magnetic flux density. A decrease in the magnetic flux density in turn leads to an increase in the copper loss of the motor, thereby reducing the motor efficiency. The problem with reducing the sheet thickness is that it involves reducing the sheet thickness of a hot-rolled steel sheet or increasing the cold-rolling reduction ratio, which results in reduced productivity.

If a non-oriented electrical steel sheet with a low iron loss in the high magnetic-flux-density region can be developed without causing a decrease in the magnetic flux density or a decrease in the productivity, it would contribute significantly to reducing the size and increasing the efficiency of electrical devices.

As a technology for obtaining a non-oriented electrical steel sheet with a low iron loss in the high magnetic-flux-density region, for example, Patent Literature 1 discloses a method that controls the crystal orientation (texture) of steel by adding P so as to increase the magnetic flux density as well as achieve a low iron loss in the high magnetic-flux-density region.

### CITATION LIST

### Patent Literature

Patent Literature 1: JP-A-2018-012854

### SUMMARY OF INVENTION

### Technical Problem

However, as P is an element that segregates at grain boundaries and causes embrittlement of steel, the technology disclosed in Patent Literature 1 cannot stably attain a low iron loss in the high magnetic-flux-density region, and therefore cannot sufficiently meet the recent requirements for non-oriented electrical steel sheets.

The present invention has been developed in view of the above-described problems faced by the conventional technology, and an object thereof is to provide a non-oriented electrical steel sheet with a low iron loss in a high magnetic-flux-density region that does not cause a decrease in the magnetic flux density or a decrease in the productivity, and to propose an advantageous production method thereof.

### Solution to Problem

To solve the above challenge, the present inventors vigorously conducted studies with a focus on the influence that the surface condition of a non-oriented electrical steel sheet had on its magnetic properties. Specifically, with the content of Co in the steel controlled to be within a predetermined range, we performed electrolytic alkali degreasing treatment (hereinafter referred to as “electrolytic degreasing treatment,” “electrolytic alkali treatment,” or “alkali treatment”) under predetermined conditions on the steel sheet before finishing annealing, and then performed finishing annealing with a low dew point of −70 to −10 °C so as to control the amount of nitrogen in a surface layer to be within a predetermined range. As a result, we could reduce the iron loss in the high magnetic-flux-density region without causing a decrease in the magnetic flux density, and this finding led us to develop the present invention.

A non-oriented electrical steel sheet according to the present invention that is based on this insight is configured as follows.

[1] A non-oriented electrical steel sheet having an ingredient composition containing, in mass %, C: 0.0050% or less, Si: 2.0 to 6.5%, Mn: 0.05 to 2.00%, P: 0.10% or less, S: 0.0050% or less, Al: 0.3 to 2.0%, N: 0.0010% to 0.0050%, Co: 0.0010 to 0.010%, Ti: 0.0030% or less, Nb: 0.0030% or less, and O: 0.0050% or less, with the balance being Fe and unavoidable impurities, and having an oxide layer containing Si, Al, and Co on a surface of the steel sheet on at least one side, wherein: an amount of nitrogen (NasAlN) in a steel sheet surface layer that is present as AlN in a layer from a surface of the steel sheet to 1/20 of a sheet thickness is 0.01 mass % or less; an amount of nitrogen Nc at a central portion of the steel sheet in the sheet thickness and the amount of nitrogen (NasAlN) in the steel sheet surface layer meet the following Formula (1): (NasAlN)/Nc≤3.0 . . . (1); and an iron loss value of the steel sheet excited at 50 Hz and 1.7 T is 3.2 W/kg or less.

[2] The non-oriented electrical steel sheet of [1] described above, wherein an Al concentration in the oxide layer provided on the surface of the steel sheet is 10 at % or higher.

[3] The non-oriented electrical steel sheet of [1] or [2] described above, wherein the steel sheet further contains, in addition to the ingredient composition, an ingredient or ingredients of one or more groups among the following groups A to C, in mass %:
group A: one type or two types selected from Sn: 0.005 to 0.20% and Sb: 0.005 to 0.20%,
group B: one type or two or more types selected from Cu, Ni, and Cr: 0.03 to 1.0% in total, and
group C: one type or two or more types selected from Ca, Mg, and REM: 0.0005 to 0.020% in total.

[4] The non-oriented electrical steel sheet of [1] to [3] described above, wherein the steel sheet further contains, in addition to the ingredient composition, an ingredient or ingredients of one or more groups among the following groups D to G, in mass %:
group D: one type or two types selected from Ge and Ga: 0.0005 to 0.01% in total,
group E: Zn: 0.001 to 0.05%,
group F: one type or two or more types selected from Mo, As, and W: 0.001 to 0.05% in total, and
group G: one type or two or more types selected from B, Pb, and V: 0.0001 to 0.01% in total.

A production method of a non-oriented electrical steel sheet according to the present invention that is based on the above-described insight is configured as follows.

[5] A production method of a non-oriented electrical steel sheet including:

a hot rolling step of hot-rolling a steel slab into a hot-rolled sheet, the steel slab having an ingredient composition containing, in mass %, C: 0.0050% or less, Si: 2.0 to 6.5%, Mn: 0.05 to 2.00%, P: 0.10% or less, S: 0.0050% or less, Al: 0.3 to 2.0%, N: 0.0010 to 0.0050%, Co: 0.0010 to 0.010%, Ti: 0.0030% or less, Nb: 0.0030% or less, and O: 0.0050% or less, with the balance being Fe and unavoidable impurities; a cold rolling step of, after annealing the hot-rolled sheet, or without annealing the hot-rolled sheet, cold-rolling the hot-rolled sheet once, or twice or more with intermediate annealing between each cold rolling, into a cold-rolled sheet; an electrolytic degreasing treatment step of subjecting the cold-rolled sheet to electrolytic degreasing treatment; and a finishing annealing step of performing finishing annealing on the cold-rolled sheet having been subjected to the electrolytic degreasing treatment, wherein: the electrolytic degreasing treatment is performed at a charge density of 3 to 12 (C/dm²), using an alkali liquid having a concentration of 1 to 10% and a liquid temperature of 30 to 120 °C, for 1 to 15 seconds; and a dew point in the finishing annealing is −70 to −10 °C.

[6] The production method of a non-oriented electrical steel sheet of [5] described above, wherein the steel slab further contains, in addition to the ingredient composition, an ingredient or ingredients of one or more groups among the following groups A to C:
group A: one type or two types selected from Sn: 0.005 to 0.20 mass % and Sb: 0.005 to 0.20 mass %,
group B: one type or two or more types selected from Cu, Ni, and Cr: 0.03 to 1.0 mass % in total, and
group C: one type or two or more types selected from Ca, Mg, and REM: 0.0005 to 0.020 mass % in total.

[7] The production method of a non-oriented electrical steel sheet of [5] or [6] described above, wherein the steel slab further contains, in addition to the ingredient composition, an ingredient or ingredients of one or more groups among the following groups D to G, in mass %:
group D: one type or two or more types selected from Ge and Ga: 0.0005 to 0.01% in total,
group E: Zn: 0.001 to 0.05%.
group F: one type or two or more types selected from Mo, As, and W: 0.001 to 0.05% in total, and
group G: one type or two or more types selected from B, Pb, and V: 0.0001 to 0.01% in total.

[8] The production method of a non-oriented electrical steel sheet of [5] to [7] described above, wherein the alkali liquid in the electrolytic degreasing treatment is one type selected from sodium hydroxide, potassium hydroxide, calcium hydroxide, and sodium orthosilicate.

### Advantageous Effects of Invention

According to the present invention, a non-oriented electrical steel sheet with a low iron loss in a high magnetic-flux-density region can be produced, making it possible to provide a material suitable for producing a motor that achieves a reduction in size and an increase in efficiency of electrical devices.

### BRIEF DESCRIPTION OF DRAWINGS

FIG. 1 is a graph showing a relationship between Co contents and iron losses.

FIG. 2 is a graph showing a relationship between (NasAlN)/Nc ratios and iron losses.

FIG. 3A is a graph showing a relationship between charge densities and iron losses.

FIG. 3B is a graph showing a relationship between charge densities and (NasAlN)/Nc ratios.

FIG. 4A is a graph showing a relationship between alkali treatment concentrations and iron losses.

FIG. 4B is a graph showing a relationship between alkali treatment concentrations and (NasAlN)/Nc ratios.

FIG. 5A is a graph showing a relationship between alkali treatment temperatures and iron losses.

FIG. 5B is a graph showing a relationship between alkali treatment temperatures and (NasAlN)/Nc ratios.

FIG. 6A is a graph showing a relationship between alkali treatment time and iron losses.

FIG. 6B is a graph showing a relationship between alkali treatment time and (NasAlN)/Nc ratios.

### DESCRIPTION OF EMBODIMENT

First, an experiment that inspired the development of the present invention will be described.

### Experiment 1

Steel containing C: 0.0025 mass %, Si: 2.9 mass %, Mn: 0.3 mass %, P: 0.01 mass %, S: 0.0019 mass %, Al: 0.6 mass %, N: 0.0023 mass %, Ti: 0.0015 mass %, Nb: 0.0009 mass %, and O: 0.0020 mass %, and further containing Co varying within a range of 0.0001 to 0.02 mass %, with the balance being Fe and unavoidable impurities was melted by a vacuum furnace and cast into a steel ingot. Next, the steel ingot was hot-rolled into a hot-rolled sheet with a sheet thickness of 2.0 mm, subjected to hot-band annealing of 950 °C for 30 seconds, acid-pickled, and then cold-rolled into a cold-rolled sheet with a final sheet thickness of 0.25 mm. Subsequently, the cold-rolled sheet was subjected to electrolytic treatment of being immersed for five seconds in sodium hydroxide having a concentration of 5% and a liquid temperature of 70 °C at a charge density of 5 (C/dm²) and was then subjected to finishing annealing at 1000 °C for seconds in an atmosphere of H₂: N₂=20:80 (vol % ratio) with a dew point of −45 °C.

From the finishing-annealed sheet thus obtained, test specimens measuring 30 mm wide by 180 mm long were cut out in the rolling direction (L-direction) and the width direction (C-direction), and the iron loss W_{17/50} in a high magnetic-flux-density region in the (L+C) directions was measured by Epstein test.

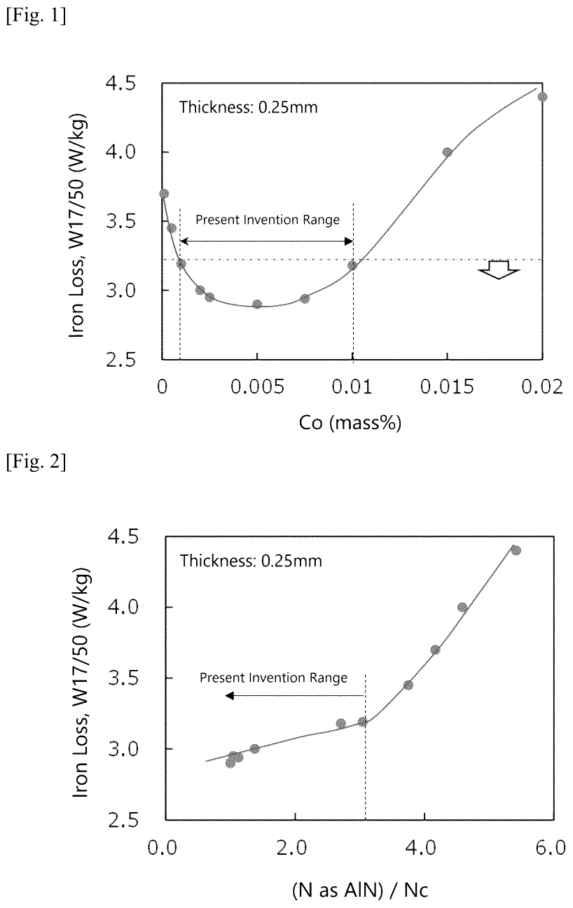

The measurement result is shown in FIG. 1, where the iron loss was reduced in a range of Co of 0.001 to 0.01 mass %.

To investigate the cause of this decrease in the iron loss resulting from adding a small amount of Co, cross-sections of finishing-annealed steel sheets in the rolling direction were observed by SEM. As a result, in a steel sheet in which the iron loss was increased, precipitation of fine AlN was observed in the steel sheet surface layer, specifically a layer from the steel sheet surface to a depth of 1/20 of the sheet thickness, and it was presumed that the iron loss had increased due to this fine nitride.

Therefore, for this finishing-annealed sheet, the concentration (mass %) of nitrogen N present as AlN in the layer from the steel sheet surface to 1/20 of the sheet thickness and the concentration (mass %) of nitrogen N at a central portion of the steel sheet were analyzed by electroextraction. As a result, it was found that the ratio between the amount of nitrogen forming AlN in the layer from the steel sheet surface to 1/20 of the sheet thickness (surface layer) and the amount of nitrogen at the central portion of the steel sheet in the sheet thickness was strongly correlated with the iron loss in the high magnetic-flux-density region. FIG. 2 shows a relationship between the ratio between the amounts of nitrogen (the surface layer nitrogen amount/the amount of nitrogen at the central portion in the sheet thickness) and the iron loss W_{17/50}. It was found that the iron loss decreased significantly when this ratio was 3.0 or less, and that in each of steel sheets in which this ratio between the nitrogen amounts was 3.0 or less, the content of Co was within a range of 0.001 to 0.01 mass %.

For those samples in which a decrease in the iron loss was recognized, the steel sheet surface was observed under a transmission electron microscope (TEM). It was revealed that an Fe—Si—Al oxide layer having a thickness of approximately 20 nm and containing Co had been formed at the steel sheet surface layer, the iron matrix interface. From these experimental results, the cause of the decrease in the iron loss recognized in the steel sheets to which a small amount of Co had been added and which had been subjected to electrolytic alkali treatment before finishing annealing and then to finishing annealing with a low dew point seems to be that the oxide layer on the steel sheet surface layer that had formed during the finishing annealing as a result of the electrolytic alkali treatment contributed to inhibiting nitridation during the finishing annealing.

Next, to investigate the influence that the charge density of electrolytic alkali treatment had on the magnetic properties of a finishing-annealed steel sheet, a steel sheet was produced as follows. Steel containing C: 0.0028 mass %, Si: 3.2 mass %, Mn: 0.6 mass %, P: 0.01 mass %, S: 0.0019 mass %, Al: 0.8 mass %, N: 0.0022 mass %, Ti: 0.0011 mass %, Nb: 0.0007 mass %, O: 0.0020 mass %, and Co: 0.0027%, with the balance being Fe and unavoidable impurities was smelted by a vacuum furnace and cast into a steel ingot. Next, the steel ingot was hot-rolled into a hot-rolled sheet with a sheet thickness of 2.2 mm, subjected to hot-band annealing of 980 °C for 30 seconds, acid-pickled, and then cold-rolled into a cold-rolled sheet with a final sheet thickness of 0.35 mm. Subsequently, this cold-rolled sheet was subjected to electrolytic treatment by being immersed in 3% sodium hydroxide having a liquid temperature of 90 °C for eight seconds, with the charge density varied between 1 and 15 (C/dm²). Next, the electrolytically treated cold-rolled sheet was subjected to finishing annealing at 970 °C for 10 seconds in an atmosphere of H₂: N₂=20:80 in vol % ratio, with a dew point of −50 °C.

To investigate the influence that the alkali treatment concentration had on the magnetic properties of a finishing-annealed steel sheet, a steel sheet was produced as follows. Steel containing C: 0.0028 mass %, Si: 3.2 mass %, Mn: 0.6 mass %, P: 0.01 mass %, S: 0.0019 mass %, Al: 0.8 mass %, N: 0.0022 mass %, Ti: 0.0011 mass %, Nb: 0.0007 mass %, O: 0.0020 mass %, and Co: 0.0027%, with the balance being Fe and unavoidable impurities was smelted by a vacuum furnace and cast into a steel ingot. Next, the steel ingot was hot-rolled into a hot-rolled sheet with a sheet thickness of 2.2 mm, subjected to hot-band annealing at 980 °C for 30 seconds, acid-pickled, and then cold-rolled into a cold-rolled sheet with a final sheet thickness of 0.35 mm. Subsequently, this cold-rolled sheet was electrolytically treated by being immersed in potassium hydroxide having a liquid temperature of 90 °C and varied between 0.5 and 20%, for six seconds at a charge density of 4 (C/dm²). Next, the electrolytically treated cold-rolled sheet was subjected to finishing annealing at 980 °C for 10 seconds in an atmosphere of H₂: N₂=20:80 in vol % ratio, with a dew point of −55 °C.

Further, to investigate the influence that the alkali treatment temperature had on the magnetic properties of a finishing-annealed steel sheet, a steel sheet was produced as follows. Steel containing C: 0.0028 mass %, Si: 3.2 mass %, Mn: 0.6 mass %, P: 0.01 mass %, S: 0.0019 mass %, Al: 0.8 mass %, N: 0.0022 mass %, Ti: 0.0011 mass %, Nb: 0.0007 mass %, O: 0.0020 mass %, and Co: 0.0027%, with the balance being Fe and unavoidable impurities was smelted by a vacuum furnace and cast into a steel ingot. Next, the steel ingot was hot-rolled into a hot-rolled sheet with a sheet thickness of 2.2 mm, subjected to hot-band annealing at 980 °C for 30 seconds, acid-pickled, and then cold-rolled into a cold-rolled sheet with a final sheet thickness of 0.35 mm. Subsequently, this cold-rolled sheet was electrolytically treated by being immersed in 3% calcium hydroxide with the liquid temperature varied between 20 and 150 °C, for four seconds at a charge density of 4 (C/dm²). Next, the electrolytically treated cold-rolled sheet was subjected to finishing annealing at 980 °C for 10 seconds in an atmosphere of H₂: N₂=20:80 in vol % ratio, with a dew point of −55 °C.

To investigate the influence that the alkali treatment time had on the magnetic properties of a finishing-annealed steel sheet, a steel sheet was produced as follows. Steel containing C: 0.0028 mass %, Si: 3.2 mass %, Mn: 0.6 mass %, P: 0.01 mass %, S: 0.0019 mass %, Al: 0.8 mass %, N: 0.0022 mass %, Ti: 0.0011 mass %, Nb: 0.0007 mass %, O: 0.0020 mass %, and Co: 0.0027%, with the balance being Fe and unavoidable impurities was melted by a vacuum furnace and cast into a steel ingot. The steel ingot was hot-rolled into a hot-rolled sheet with a sheet thickness of 2.2 mm, subjected to hot-band annealing at 980 °C for 30 seconds, acid-pickled, and then cold-rolled into a cold-rolled sheet with a final sheet thickness of 0.35 mm. Subsequently, this cold-rolled sheet was subjected to electrolytic treatment by being immersed in 3% sodium hydroxide having a liquid temperature of 35 °C, at a charge density of 3 (C/dm²) for a time varied between 5 and 30 seconds. Next, the electrolytically treated cold-rolled sheet was subjected to finishing annealing at 980 °C for 10 seconds in an atmosphere of H₂: N₂=20:80 in vol % ratio, with a dew point of −60 °C.

From the finishing-annealed sheets thus obtained, test specimens measuring 30 mm wide by 180 mm long were cut out in the rolling direction (L-direction) and the width direction (C-direction), and the iron loss W_{17/50} in the high magnetic-flux-density region in the (L+C) directions was measured by Epstein test. Further, the amount of nitrogen (N as AlN) in the steel sheet surface layer and the amount of nitrogen at the central portion of the steel sheet in the sheet thickness were analyzed by extraction residue.

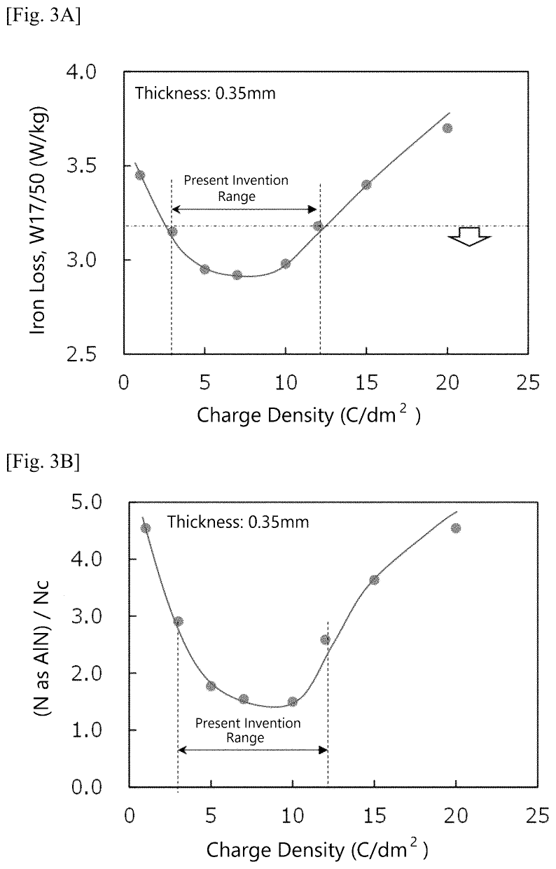

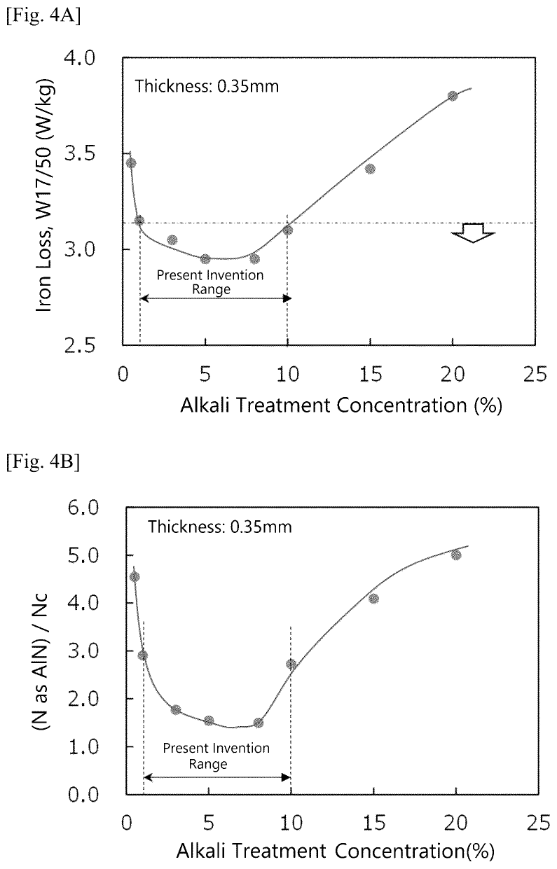

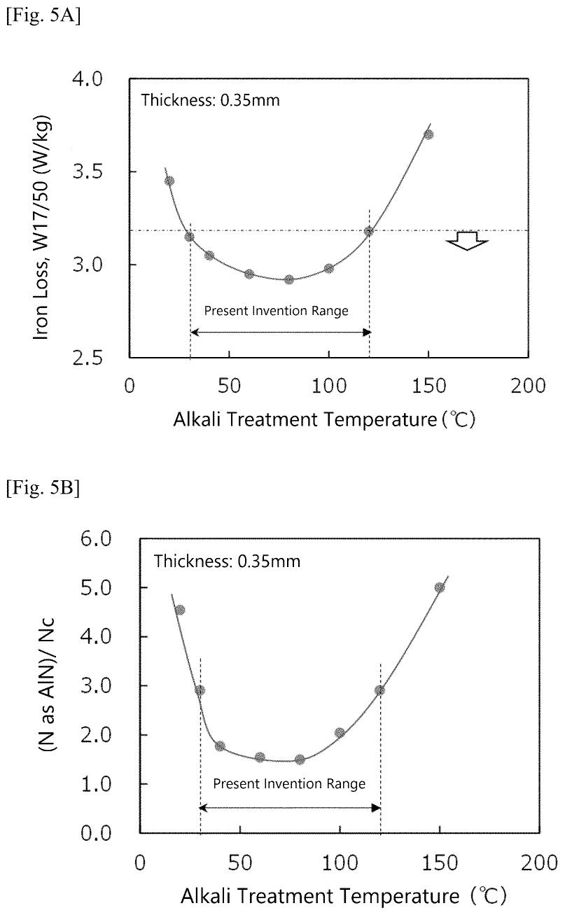

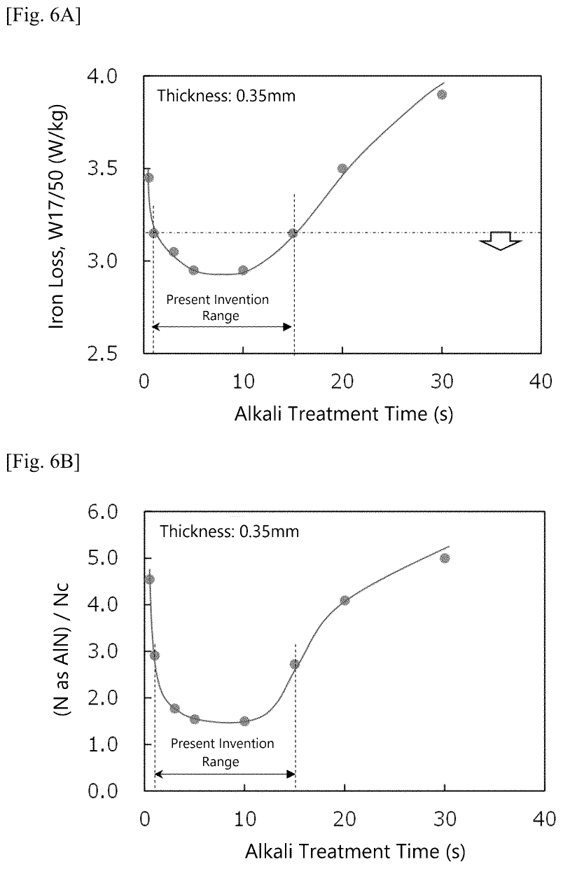

The measurement results are shown in FIG. 3, FIG. 4, FIG. 5, and FIG. 6. A decrease in the iron loss was recognized at a charge density of the electrolytic alkali treatment of 3 to 12 (C/dm²), an alkali treatment concentration of 1 to 10%, an alkali treatment time of 1 to 15 seconds, and an alkali treatment temperature of 30 to 120 °C. This is because when the charge density is low, the alkali treatment concentration is low, the alkali treatment temperature is low, or the alkali treatment time is short, the steel sheet surface is not sufficiently degreased, so that an oxide layer containing Co is not formed during finishing annealing and nitride is generated during finishing annealing. Another possible reason is that when the charge density is high, the alkali treatment concentration is high, the alkali treatment temperature is high, or the alkali treatment time is long, the oxide layer on the steel sheet surface layer formed during finishing annealing becomes thick and nitridation during finishing annealing is promoted through the resulting oxide film.

From these results, it was learned that setting the content of Co in steel to be within a predetermined range, performing electrolytic alkali degreasing treatment under predetermined conditions on the steel sheet before finishing annealing, and performing finishing annealing with a low dew point could reduce the amount of nitrogen in the steel sheet surface layer and reduce the iron loss, which led to the development of the present invention.

### <Non-Oriented Electrical Steel Sheet>

A non-oriented electrical steel sheet according to the present embodiment will be described.

First, reasons for restricting the ingredient composition of the non-oriented electrical steel sheet will be described. Unless otherwise noted, the indication of “%” relating to an ingredient means “mass %.”

### C: 0.0050% or Less

C is a harmful element that causes magnetic aging and precipitates by forming carbide, thereby degrading the iron loss properties. Therefore, the content of C is restricted to 0.0050% or less. The content of C is preferably 0.0040% or less. While the lower limit of the content of C is not particularly specified, from the viewpoint of reducing the decarburization cost in a refining step, the lower limit is preferably approximately 0.0001%.

### Si: 2.0 to 6.5%

Si has an effect of enhancing the specific resistance of steel and reducing the iron loss. In addition, Si has an effect of enhancing the strength of steel through solid-solution strengthening. Therefore, the content of Si should be 2.0% or more. On the other hand, when the content of Si exceeds 6.5%, rolling becomes difficult. Therefore, the upper limit of the content of Si is 6.5%. The content of Si is preferably 2.5 to 6.0%.

### Mn: 0.05 to 2.00%

Like Si, Mn is a useful element for enhancing the specific resistance and the strength of steel. Moreover, Mn is an element that improves hot brittleness by forming sulfide. Therefore, the content of Mn should be 0.05% or more. On the other hand, when the content of Mn exceeds 2.00%, slab cracking etc. occurs and the operability in steelmaking deteriorates. Therefore, the upper limit is 2.00%. The content of Mn is preferably within a range of 0.10 to 1.50%.

### P: 0.10% or Less

P is an element that is highly effective in enhancing the specific resistance and reducing the eddy-current loss, and therefore can be added as appropriate. However, excessive addition of P causes degradation of cold rollability. Therefore, the upper limit of the content of P is 0.10%. The content of P is preferably 0.05% or less.

To obtain the aforementioned effect, the content of P is preferably 0.001% or more.

### S: 0.0050% or Less

S forms a precipitate or an inclusion by turning into sulfide, thereby degrading the productivity (hot rollability) and the magnetic properties of the product sheet. For this reason, containing less is preferable. In the present invention, therefore, the upper limit of the content of S is 0.0050%. The content of S is preferably 0.0030% or less.

### Al: 0.3 to 2.0%

Like Si, Al has an effect of enhancing the specific resistance of steel and reducing the iron loss. However, when the content of Al exceeds 2.0%, steel becomes brittle and difficult to roll. Therefore, the upper limit is 2.0%. On the other hand, when the content of Al is less than 0.3%, Al precipitates by forming fine nitride and conversely degrades the iron loss properties. Therefore, the lower limit is 0.3%. The content of Al is preferably 0.4 to 1.5%.

### N: 0.0010 to 0.0050%

N is a harmful element that forms nitride and degrades the magnetic properties, and is therefore restricted to 0.0050% or less. On the other hand, restricting the content of N to 0.0010% or less leads to a significant rise in the cost of the refining step. Therefore, the lower limit is 0.0010%. The content of N is preferably 0.0015 to 0.0040%.

### Co: 0.0010 to 0.010%

As described above, Co has an effect of inhibiting nitridation during finishing annealing. Therefore, the content of Co should be 0.0010% or more. On the other hand, when the content of Co exceeds 0.010%, for some unknown reason, an oxide film layer (nitridation inhibiting layer) containing Co is not formed by electrolytic alkali pretreatment. Therefore, the content of Co is restricted to 0.010% or less. The content of Co is preferably 0.002 to 0.007%.

### Ti: 0.0030% or Less

Ti is a harmful element that precipitates by forming fine carbonitride and increases the iron loss. In particular, when the content of Ti exceeds 0.0030%, the aforementioned adverse effect becomes noticeable. Therefore, the upper limit is 0.0030%. The content of Ti is preferably 0.0020% or less.

### Nb: 0.0030% or Less

Nb is a harmful element that precipitates by forming fine carbonitride and increases the iron loss. In particular, when the content of Nb exceeds 0.0030%, the aforementioned adverse effect becomes noticeable. Therefore, the upper limit is 0.0030%. The content of Nb is preferably 0.0020% or less.

### O: 0.0050% or Less

O is a harmful element that forms oxide and degrades the magnetic properties. Therefore, the content of O is restricted to 0.0050% or less. The content of O is preferably 0.0040% or less.

The balance of the non-oriented electrical steel sheet according to this embodiment other than the above-described ingredients is Fe and unavoidable impurities. To improve the properties, it is preferable that, in addition to the above-described ingredient composition of the non-oriented electrical steel sheet, an ingredient or ingredients of at least one group selected from the following groups A to C be contained.

Group A: one type or two types selected from Sn: 0.005 to 0.20% and Sb: 0.005 to 0.20%

Sn and Sb have an effect of improving the recrystallization texture and thereby improving the magnetic flux density and the iron loss. To achieve this effect, it is necessary to add Sn and Sb each at a content of 0.005% or more. However, adding Sn and Sb each at a content exceeding 0.20% only saturates the aforementioned effect. Therefore, the contents of Sn and Sb are each preferably 0.005 to 0.20%.

Group B: One Type or Two or More Types Selected from Cu, Ni, and Cr: 0.03 to 1.0% in Total

Cu, Ni, and Cr have an effect of raising the specific resistance and reducing the iron loss. To obtain this effect, the total content of one type or two or more types selected from Cu, Ni, and Cr should be 0.03% or more. Adding one type or two or more types selected from Cu, Ni, and Cr at a content of 1.0% or more in total causes a cost increase. Therefore, the total content of one type or two or more types selected from Cu, Ni, and Cris preferably 0.03 to 1.0%. The total content of one type or two or more types selected from Cu, Ni, and Cris more preferably 0.05 to 0.8%.

Group C: One Type or Two or More Types Selected from Ca, Mg, and REM: 0.0005 to 0.020% in Total

Ca, Mg, and REM have an effect of improving the grain growability by forming stable sulfide. To obtain this effect, the total content of one type or two or more types among Ca, Mg, and REM should be 0.0005% or more. However, adding them at a content exceeding 0.020% only saturates the aforementioned effect. Therefore, the total content of one type or two or more types among Ca, Mg, and REM is preferably 0.0005 to 0.020%.

To improve the properties, it is preferable that, in addition to the above-described ingredient composition of the non-oriented electrical steel sheet, an ingredient or ingredients of at least one group selected from the following groups D to G be further contained.

Group D: One Type or Two Types Selected from Ge and Ga: 0.0005 to 0.01% in Total.

Ge and Ga are elements that have an effect of improving the texture. When adding one or both of Ge and Ga, a total content of Ge and Ga lower than 0.0005% is not sufficient for obtaining this effect. Therefore, the total content should be 0.0005% or more. The total content of Ge and Ga is preferably 0.0020% or more.

On the other hand, adding Ge and Ga at a content exceeding 0.01% in total only saturates the aforementioned effect and raises the alloy cost. Therefore, the total content of Ge and Ga should be 0.01% or less and is preferably within a range of 0.0050% or less.

### Group E: Zn: 0.001 to 0.05%

Zn is an element that has an effect of inhibiting nitridation during finishing annealing. When adding Zn, the content of Zn should be 0.001 mass % or more, preferably 0.002% or more. On the other hand, when the content of Zn exceeds 0.05 mass %, Zn forms sulfide and conversely increases the iron loss. Therefore, the content of Zn is restricted to 0.05 mass % or less. The content of Zn is preferably within a range of 0.002 to 0.01 mass %.

Group F: One Type or Two or More Types Selected from Mo, as, and W: 0.001 to 0.05% in Total

Mo, As, and W are elements that have an effect of improving the high-temperature strength. Adding one type or two or more types among Mo, As, and W can inhibit surface defects (scabs) in the non-oriented electrical steel sheet.

Being high-alloy steel, the steel sheet of the present invention is prone to surface oxidation and thus has a high incidence rate of scabs attributable to surface cracking. Therefore, one type or two or more types among Mo, As, and W can be added to inhibit the cracking.

When adding one type or two or more types among Mo, As, and W, to sufficiently obtain the aforementioned effect, the total content of Mo, As, and W should be 0.001% or more, preferably 0.005% or more. On the other hand, when the total content exceeds 0.05%, the aforementioned effect saturates and the alloy cost increases. Therefore, the total content should be 0.05% or less, preferably 0.02% or less.

Group G: One Type or Two or More Types Selected from B, Pb, and V: 0.0001 to 0.01% in Total

B, Pb, and V are elements that have an effect of improving the toughness of the steel sheet by segregating at grain boundaries. Adding one type or two or more types among B, Pb, and V can improve the toughness of the non-oriented electrical steel sheet.

Being high-alloy steel, the steel sheet of the present invention may have low toughness. Therefore, one type or two or more types among B, Pb, and V can be added to improve the toughness. When adding one type or two or more types among B, Pb, and V, to sufficiently obtain the aforementioned effect, the total content of B, Pb, and V should be 0.0001% or more, preferably 0.0005% or more. On the other hand, when the total content exceeds 0.01%, carbonitride forms, causing an increase in the iron loss. Therefore, the total content should be 0.01% or less, preferably 0.0050% or less.

### Oxide Layer Containing Si, Al, and Co on Surface of Steel Sheet

An oxide layer containing Si, Al, and Co inhibits nitridation in the steel sheet surface and achieves a low iron loss. Therefore, an oxide layer containing Si, Al, and Co is provided on the surface of the steel sheet on at least one side. The oxide may be amorphous or may be a crystal phase or may be a composite oxide of an amorphous oxide and a crystalline oxide. The ratio of the crystal phase to the total of the amorphous phase and the crystal phase included in the oxide layer is preferably 0% or more and 30% or less, and more preferably 0% or more and 10% or less.

### Al Concentration in Oxide Layer: 10 at % or Higher

Of the elements included in the oxide layer, those that have a nitridation inhibiting effect are Al and Co, and the Al concentration is preferably 10 at % or higher. As the Al concentration becomes higher, the oxide film becomes denser, which enhances the nitridation inhibiting effect during finishing annealing.

The amount of Co to be added is not particularly specified, because the amount of Co to be added is small and Co exhibits a nitridation inhibiting effect when included in the oxide layer, with that effect varying little according to the concentration of Co.

To obtain the oxide film with an Al concentration of 10 at % or higher, it is preferable that the charge density of electrolytic alkali treatment be 5 to 10 (C/dm²).

From the viewpoint of inhibiting nitridation, the thickness of the aforementioned oxide layer is preferably 5 nm or more. On the other hand, when the oxide layer is excessively thick, the occupancy rate of the steel sheet decreases. Therefore, the thickness of the oxide layer is preferably 50 nm or less.

The ratio of the crystal phase and the thickness of the oxide layer can be measured by observation under a transmission electron microscope (TEM) or a scanning transmission electron microscope (STEM), as well as by an energy dispersive X-ray spectroscopy (EDS) analysis.

Specifically, an STEM-EDS element distribution map is measured using a beam system of 1 nm or less with 50,000 or higher magnification, and then a TEM image is acquired at 300,000 or higher magnification. From the STEM-EDS element distribution map and the TEM image thus obtained, regions where Al and O are present and where a lattice fringe is recognizable are regarded as a crystal phase, and other regions where Al and O are present are regarded as an amorphous phase. Subsequently, the areas of both phases are obtained, and from that result, the area ratio of the crystal phase to the total area of the amorphous phase and the crystal phase is calculated.

As for the thickness of the oxide layer, the thickness of an Al region in the STEM-EDS element analysis map can be measured. Specifically, an EDS-line profile is acquired at 0.5 nm intervals, and from the obtained element distribution of Al, Si, Co, and O, a region where the weight fraction of O is 10% or more and the weight fraction of Al, Si, and Co is 3% or more is defined as an oxide layer.

Fe may be contained in the oxide layer. While not particularly specified, the upper limit of the Fe concentration in the oxide layer is preferably less than 100% as a ratio to Al, Si, or the total of Al and Si. Measurement can be performed by STEM-EDS (100,000 magnification) etc.

Amount of nitrogen (NasAlN) in steel sheet surface layer present as AlN in layer from surface of steel sheet to 1/20 of sheet thickness: 0.01 mass % or less

When a precipitate of fine AlN is present in the steel sheet surface layer, the iron loss in the high magnetic-flux-density region increases and the magnetic properties degrade. Therefore, formation of AlN needs to be inhibited. An index of AlN is represented by the amount of nitrogen present as AlN. This amount of nitrogen (NasAlN) in the steel sheet surface layer that is present as AlN should be 0.01 mass % or less.

Amount of nitrogen Nc at the central portion of the steel sheet in the sheet thickness and amount of nitrogen (NasAlN) in steel sheet surface layer meeting Formula (1)

(NasAlN)/Nc≤3.0 (1)

The ratio between the amount of nitrogen forming AlN in the layer from the steel sheet surface to 1/20 of the sheet thickness (surface layer) and the amount of nitrogen at the central portion of the steel sheet in the sheet thickness is strongly correlated with the iron loss in the high magnetic-flux-density region. Since the iron loss decreases significantly when the ratio between the amounts of nitrogen is 3.0 or less, the ratio between the amounts of nitrogen should be 3.0 or less.

Magnetic Properties: Iron Loss of Steel Sheet being 3.2 W/Kg or Less

If the iron loss exceeds 3.2 W/kg, when a motor is driven in a high torque region, the motor is found to heat up or decrease in efficiency. Therefore, the iron loss of the steel sheet should be 3.2 W/kg or less.

### <Production Method of Non-Oriented Electrical Steel Sheet>

Next, the production method of a non-oriented electrical steel sheet according to this embodiment will be described.

This production method of a non-oriented electrical steel sheet includes: a hot rolling step of hot-rolling a steel slab having the above-described ingredient composition into a hot-rolled sheet; a cold rolling step of, after annealing the hot-rolled sheet or without annealing the hot-rolled sheet, cold-rolling the hot-rolled sheet once, or twice or more with intermediate annealing between each cold rolling, into a cold-rolled sheet; an electrolytic degreasing treatment step of subjecting the cold-rolled sheet to electrolytic degreasing treatment; and a finishing annealing step of performing finishing annealing on the cold-rolled sheet having been subjected to the electrolytic degreasing treatment. The electrolytic degreasing treatment is performed at a charge density of 3 to 12 (C/dm²), using an alkali liquid having a concentration of 1 to 10% and a liquid temperature of 30 to 120 °C, for 1 to 15 seconds. In the finishing annealing, the dew point is −70 to −10 °C. In the following, this production method will be specifically described.

### Steel Slab

First, the steel slab used for producing the non-oriented electrical steel sheet according to this embodiment can be typically produced by melting steel having an ingredient composition in accordance with the present invention described above by a commonly known refining process using a convertor, an electric furnace, a vacuum degassing apparatus, etc. and then performing an ordinary method such as a continuous casting method or an ingot making-blooming method. A thin cast slab with a thickness of 100 mm or less may be produced by a direct casting method.

### Hot Rolling Step

The steel slab is then typically hot-rolled into a hot-rolled sheet by a commonly known method. In this case, the steel slab is normally subjected to hot rolling after being reheated to a predetermined temperature by a heating furnace, but may instead be directly subjected to hot rolling after casting without reheating. In the case of a thin cast slab, the slab may be hot-rolled or may be subjected to the subsequent steps without hot rolling.

### Hot-Band Annealing

The hot-rolled sheet may be annealed or subjected to the subsequent steps without annealing. In hot-band annealing after hot rolling, the soaking temperature is preferably within a range of 800 to 1100 °C. When the soaking temperature is lower than 800 °C, the effect of hot-band annealing is small and a sufficient improving effect on the magnetic properties cannot be obtained. On the other hand, when the soaking temperature exceeds 1100 °C, crystal grains coarsen, which may promote brittle breaking (sheet fracture) during cold rolling or be disadvantageous in terms of the production cost. From the viewpoint of securing the productivity, the soaking time is preferably three minutes or less. More preferably, the soaking temperature is 850 to 1000 °C and the soaking time is one minute or less.

### Cold Rolling Step

Cold rolling is a step in which the hot-band-annealed sheet that has undergone acid pickling is cold-rolled to a sheet thickness of a product sheet (final sheet thickness).

The steel sheet after the hot-band annealing is next cold-rolled once, or twice or more with intermediate annealing between each cold rolling, into a cold-rolled sheet with the final sheet thickness. While not particularly specified, the final sheet thickness in cold rolling (product sheet thickness) is preferably 0.50 mm or less from the viewpoint of achieving an iron loss reducing effect.

### Electrolytic Degreasing Treatment Step

The cold-rolled sheet is then subjected to electrolytic treatment using an alkali liquid. To form a nitridation inhibiting layer (oxide layer) during finishing annealing, the conditions of the electrolytic alkali treatment are as follows: the charge density 3 to 12 (C/dm²); the alkali liquid concentration 1 to 10%; the treatment temperature 30 to 120 °C; and 1 to 15 seconds. Here, the alkali liquid is one type selected from sodium hydroxide, potassium hydroxide, calcium hydroxide, and sodium orthosilicate.

To obtain an oxide layer in which the Al concentration is 10 at % or higher, the charge density is preferably 5 to 10 (C/dm²).

### Finishing Annealing Step

Next, finishing annealing is performed on the cold-rolled sheet having been subjected to electrolytic degreasing treatment. In the present invention, finishing annealing is performed with a low dew point. Specifically, finishing annealing is performed with a dew point of −70 to −10 °C. This is because when the dew point exceeds −10 °C, an oxide layer is formed inside the steel sheet and the intended nitridation inhibiting layer (oxide layer) is not formed on the surface layer of the steel sheet. In addition, a low dew point lower than −70 °C industrially incurs a high cost. Therefore, the dew point in finishing annealing should be −70 to −10 °C.

Moreover, in finishing annealing, from the viewpoint of coarsening the crystal grain diameter and further reducing the iron loss, the soaking temperature in finishing annealing is preferably 900 to 1200 °C, and more preferably 1000 to 1100 °C. For the same reason, the soaking time in finishing annealing is preferably 1 to 120 seconds, more preferably 5 to 60 seconds.

The steel sheet having undergone the finishing annealing is then coated with an insulation coating as necessary to be a product sheet. Without being particularly limited, this insulation coating may be made of any one of an inorganic material, an organic material, and a mixture of inorganic and organic materials.

### EXAMPLES

Slabs having the various ingredient compositions shown in Tables 1-1 to 1-7 were heated at 1100 °C for 30 minutes and then hot-rolled into hot-rolled sheets with a sheet thickness of 1.9 mm. These hot-rolled sheets were then subjected to hot-band annealing under the conditions of 980 °C for 30 seconds, acid-pickled, and then cold-rolled into cold-rolled sheets with a final sheet thickness. These cold-rolled sheets were subjected to alkali treatment and then finishing annealing (induction heating and radiation heating) to obtain product sheets. The conditions of the cold rolling, the electrolytic degreasing treatment, and the finishing annealing are shown in Tables 2-1 to 2-7.

Samples were taken from the product sheets thus obtained. Test specimens measuring 30 mm wide by 180 mm long were cut out from the rolling direction (L-direction) and the width direction (C-direction), and the iron loss W_{17/50} in the (L+C) directions was measured by Epstein test. Test specimens were further taken from these samples, and an electroextraction analysis was performed to analyze the nitrogen concentration N (mass %) from the steel sheet surface to a depth of 1/20 of the sheet thickness and the nitrogen concentration N (mass %) at the central portion of the steel sheet. In addition, the thickness of the oxide layer on the surface layer was observed under a TEM and an STEM.

The results are included in Tables 2-1 to 2-7. From these results, it can be seen that each of the steel sheets that were produced using steel materials (slabs) having ingredient compositions in accordance with the present invention under conditions in accordance with the present invention has excellent iron loss properties. On the surfaces of the steel sheets of the invention examples, an Fe—Si—Al oxide layer containing Co was observed.

As for the iron loss, those steel sheets in which the iron loss value when the steel sheets were excited at 50 Hz and 1.7 T was 3.2 W/kg or less were regarded as the invention examples.

In steel types No. 14, 15, and 18, slab cracking occurred, so that the steel sheet properties could not be evaluated. In No. 21, cracking occurred during cold rolling, and in No. 64, cracking occurred during hot rolling, so that the steel sheet properties of neither could be evaluated.

The present invention can achieve a lower iron loss in the high magnetic-flux-density region without reducing the magnetic flux density, and therefore can be suitably used as a motor core material of a hybrid electric vehicle, an all-electric vehicle, a power generator, an air conditioner compressor, a vacuum cleaner, a machine tool, and others.

TABLE 1-1

| | Ingredient composition (mass %) | | | | | | | | | |
|---|---|---|---|---|---|---|---|---|---|---|
| No. | C | Si | Mn | P | S | Al | Co | Ti | Nb | O |
| 1 | 0.0025 | 3.5 | 0.4 | 0.01 | 0.0019 | 0.8 | 0.0011 | 0.0011 | 0.0009 | 0.0024 |
| 2 | 0.0025 | 3.5 | 0.4 | 0.01 | 0.0019 | 0.8 | 0.0031 | 0.0011 | 0.0009 | 0.0024 |
| 3 | 0.0025 | 3.5 | 0.4 | 0.01 | 0.0019 | 0.8 | 0.0031 | 0.0011 | 0.0009 | 0.0024 |
| 4 | 0.0025 | 3.5 | 0.4 | 0.01 | 0.0019 | 0.8 | 0.0031 | 0.0011 | 0.0009 | 0.0024 |
| 5 | 0.0025 | 3.5 | 0.4 | 0.01 | 0.0019 | 0.8 | 0.0002 | 0.0011 | 0.0009 | 0.0024 |
| 6 | 0.0025 | 1.9 | 0.5 | 0.01 | 0.0019 | 0.6 | 0.0029 | 0.0013 | 0.0011 | 0.0025 |
| 7 | 0.0025 | 3.8 | 0.5 | 0.01 | 0.0019 | 0.6 | 0.0029 | 0.0013 | 0.0011 | 0.0025 |
| 8 | 0.0025 | 3.8 | 0.5 | 0.01 | 0.0019 | 0.6 | 0.0029 | 0.0013 | 0.0011 | 0.0025 |
| 9 | 0.0025 | 3.8 | 0.5 | 0.01 | 0.0019 | 0.6 | 0.0029 | 0.0013 | 0.0011 | 0.0025 |
| 10 | 0.0025 | 3.8 | 0.5 | 0.01 | 0.0019 | 0.6 | 0.0029 | 0.0013 | 0.0011 | 0.0025 |
| 11 | 0.0025 | 3.8 | 0.5 | 0.01 | 0.0019 | 0.6 | 0.0029 | 0.0013 | 0.0011 | 0.0025 |
| 12 | 0.0028 | 3.2 | 0.8 | 0.01 | 0.0024 | 1.2 | 0.0024 | 0.0008 | 0.0012 | 0.0021 |
| 13 | 0.0028 | 3.2 | 0.8 | 0.01 | 0.0024 | 1.8 | 0.0024 | 0.0008 | 0.0012 | 0.0021 |
| 14 | 0.0029 | 3.5 | 2.5 | 0.01 | 0.0024 | 0.5 | 0.0021 | 0.0008 | 0.0011 | 0.0021 |
| 15 | 0.0025 | 3.3 | 0.1 | 0.01 | 0.0024 | 2.5 | 0.0045 | 0.0008 | 0.0011 | 0.0021 |
| 16 | 0.0019 | 4.2 | 0.3 | 0.01 | 0.0015 | 0.3 | 0.0026 | 0.0014 | 0.0012 | 0.0019 |
| 17 | 0.0019 | 5.6 | 0.3 | 0.01 | 0.0015 | 0.3 | 0.0027 | 0.0014 | 0.0012 | 0.0019 |
| 18 | 0.0022 | 7.2 | 0.2 | 0.01 | 0.0024 | 0.3 | 0.0038 | 0.0008 | 0.0011 | 0.0021 |
| 19 | 0.0021 | 4.0 | 0.4 | 0.01 | 0.0026 | 0.6 | 0.0032 | 0.0011 | 0.0013 | 0.0028 |
| 20 | 0.0021 | 4.0 | 0.4 | 0.01 | 0.0026 | 0.6 | 0.0032 | 0.0011 | 0.0013 | 0.0028 |

| | Ingredient composition (mass %) | | | | | | | | |
|---|---|---|---|---|---|---|---|---|---|
| No. | N | Sn | Sb | Cu | Cr | Ni | Ca | Mg | REM |
| 1 | 0.0027 | 0.03 | — | — | — | — | — | — | — |
| 2 | 0.0027 | 0.03 | — | — | — | — | — | — | — |
| 3 | 0.0027 | 0.03 | — | — | — | — | — | — | — |
| 4 | 0.0027 | 0.03 | — | — | — | — | — | — | — |
| 5 | 0.0027 | 0.03 | — | — | — | — | — | — | — |
| 6 | 0.0024 | — | — | — | — | — | — | — | — |
| 7 | 0.0024 | — | — | — | — | — | — | — | — |
| 8 | 0.0024 | — | — | — | — | — | — | — | — |
| 9 | 0.0024 | — | — | — | — | — | — | — | — |
| 10 | 0.0024 | — | — | — | — | — | — | — | — |
| 11 | 0.0024 | — | — | — | — | — | — | — | — |
| 12 | 0.0019 | 0.03 | — | — | — | — | — | — | — |
| 13 | 0.0020 | 0.03 | — | — | — | — | — | — | — |
| 14 | 0.0028 | — | — | — | — | — | — | — | — |
| 15 | 0.0021 | — | — | — | — | — | — | — | — |
| 16 | 0.0027 | — | 0.01 | — | — | — | — | — | — |
| 17 | 0.0027 | — | — | — | — | — | — | — | — |
| 18 | 0.0028 | — | — | — | — | — | — | — | — |
| 19 | 0.0024 | 0.03 | — | — | — | — | — | — | — |
| 20 | 0.0024 | 0.03 | — | — | — | — | — | — | — |

TABLE 1-2

| | Ingredient composition (mass %) | | | | | | | | | |
|---|---|---|---|---|---|---|---|---|---|---|
| No. | C | Si | Mn | P | S | Al | Co | Ti | Nb | O |
| 21 | 0.0026 | 3.2 | 0.1 | 0.25 | 0.0026 | 1.5 | 0.0025 | 0.0011 | 0.0013 | 0.0028 |
| 22 | 0.0024 | 3.4 | 1.2 | 0.01 | 0.0019 | 0.9 | 0.0024 | 0.0016 | 0.0014 | 0.0027 |
| 23 | 0.0024 | 3.3 | 1.8 | 0.01 | 0.0019 | 0.7 | 0.0024 | 0.0016 | 0.0014 | 0.0027 |
| 24 | 0.0018 | 3.5 | 0.2 | 0.01 | 0.0015 | 0.9 | 0.0021 | 0.0012 | 0.0009 | 0.0027 |
| 25 | 0.0017 | 3.6 | 0.5 | 0.01 | 0.0024 | 0.8 | 0.0027 | 0.0016 | 0.0014 | 0.0027 |
| 26 | 0.0017 | 3.6 | 0.5 | 0.01 | 0.0026 | 0.8 | 0.0027 | 0.0016 | 0.0014 | 0.0027 |
| 27 | 0.0017 | 3.6 | 0.5 | 0.01 | 0.0027 | 0.8 | 0.0027 | 0.0016 | 0.0014 | 0.0027 |
| 28 | 0.0025 | 3.3 | 0.6 | 0.01 | 0.0059 | 0.9 | 0.0069 | 0.0018 | 0.0013 | 0.0029 |
| 29 | 0.0025 | 3.8 | 0.2 | 0.01 | 0.0015 | 0.5 | 0.0081 | 0.0041 | 0.0013 | 0.0029 |
| 30 | 0.0025 | 3.8 | 0.2 | 0.01 | 0.0015 | 0.5 | 0.0081 | 0.0007 | 0.0038 | 0.0029 |
| 31 | 0.0025 | 3.8 | 0.2 | 0.01 | 0.0015 | 0.5 | 0.0081 | 0.0007 | 0.0011 | 0.0064 |
| 32 | 0.0025 | 3.8 | 0.2 | 0.01 | 0.0015 | 0.5 | 0.0081 | 0.0007 | 0.0011 | 0.0021 |
| 33 | 0.0021 | 4.1 | 0.5 | 0.01 | 0.0023 | 0.7 | 0.0024 | 0.0012 | 0.0013 | 0.0023 |
| 34 | 0.0021 | 4.1 | 0.5 | 0.01 | 0.0023 | 0.7 | 0.0024 | 0.0012 | 0.0013 | 0.0023 |
| 35 | 0.0021 | 4.1 | 0.5 | 0.01 | 0.0023 | 0.7 | 0.0024 | 0.0012 | 0.0013 | 0.0023 |
| 36 | 0.0026 | 3.4 | 0.9 | 0.01 | 0.0026 | 1.4 | 0.0039 | 0.0018 | 0.0012 | 0.0021 |
| 37 | 0.0026 | 3.4 | 0.9 | 0.01 | 0.0026 | 1.4 | 0.0039 | 0.0018 | 0.0012 | 0.0021 |
| 38 | 0.0026 | 3.4 | 0.9 | 0.01 | 0.0026 | 1.4 | 0.0039 | 0.0018 | 0.0012 | 0.0021 |
| 39 | 0.0025 | 3.7 | 0.8 | 0.01 | 0.0021 | 0.8 | 0.0031 | 0.0013 | 0.0013 | 0.0032 |
| 40 | 0.0025 | 3.5 | 0.4 | 0.01 | 0.0019 | 0.8 | 0.0031 | 0.0011 | 0.0009 | 0.0024 |

| | Ingredient composition (mass %) | | | | | | | | |
|---|---|---|---|---|---|---|---|---|---|
| No. | N | Sn | Sb | Cu | Cr | Ni | Ca | Mg | REM |
| 21 | 0.0024 | 0.06 | — | — | — | — | — | — | — |
| 22 | 0.0021 | 0.03 | — | — | — | — | — | — | — |
| 23 | 0.0021 | 0.03 | — | — | — | — | — | — | — |
| 24 | 0.0021 | — | 0.05 | — | — | — | — | — | — |
| 25 | 0.0021 | — | — | — | — | — | 0.0034 | — | — |
| 26 | 0.0021 | — | — | — | — | — | — | 0.0025 | — |
| 27 | 0.0021 | — | — | — | — | — | — | — | 0.0072 |
| 28 | 0.0026 | 0.04 | — | — | — | — | — | — | — |
| 29 | 0.0026 | 0.04 | — | — | — | — | — | — | — |
| 30 | 0.0026 | 0.04 | — | — | — | — | — | — | — |
| 31 | 0.0026 | 0.04 | — | — | — | — | — | — | — |
| 32 | 0.011 | 0.04 | — | — | — | — | — | — | — |
| 33 | 0.0022 | 0.03 | — | — | — | — | — | — | — |
| 34 | 0.0022 | 0.03 | — | — | — | — | — | — | — |
| 35 | 0.0022 | 0.03 | — | — | — | — | — | — | — |
| 36 | 0.0023 | 0.03 | — | — | — | — | — | — | — |
| 37 | 0.0023 | 0.03 | — | — | — | — | — | — | — |
| 38 | 0.0023 | 0.03 | — | — | — | — | — | — | — |
| 39 | 0.0031 | 0.03 | — | — | — | — | 0.0029 | — | — |
| 40 | 0.0027 | 0.03 | — | — | — | — | — | — | — |

TABLE 1-3

| | Ingredient composition (mass %) | | | | | | | | | |
|---|---|---|---|---|---|---|---|---|---|---|
| No. | O | Si | Mn | P | S | Al | Co | Ti | Nb | O |
| 41 | 0.0025 | 3.5 | 0.4 | 0.01 | 0.0019 | 0.8 | 0.0031 | 0.0011 | 0.0009 | 0.0024 |
| 42 | 0.0025 | 3.5 | 0.4 | 0.01 | 0.0019 | 0.8 | 0.0031 | 0.0011 | 0.0009 | 0.0024 |
| 43 | 0.0025 | 3.5 | 0.4 | 0.01 | 0.0019 | 0.8 | 0.0031 | 0.0011 | 0.0009 | 0.0024 |
| 44 | 0.0029 | 2.6 | 0.5 | 0.01 | 0.0022 | 0.7 | 0.0035 | 0.0019 | 0.0008 | 0.0023 |
| 45 | 0.0029 | 2.6 | 0.5 | 0.01 | 0.0022 | 0.7 | 0.0035 | 0.0019 | 0.0008 | 0.0023 |
| 46 | 0.0025 | 2.9 | 0.6 | 0.01 | 0.0025 | 1.1 | 0.0038 | 0.0022 | 0.0009 | 0.0025 |
| 47 | 0.0025 | 2.9 | 0.6 | 0.01 | 0.0025 | 1.1 | 0.0038 | 0.0022 | 0.0009 | 0.0025 |
| 48 | 0.0025 | 2.9 | 0.6 | 0.01 | 0.0025 | 1.1 | 0.0038 | 0.0022 | 0.0009 | 0.0025 |
| 49 | 0.0025 | 2.9 | 0.6 | 0.01 | 0.0025 | 1.1 | 0.0038 | 0.0022 | 0.0009 | 0.0025 |
| 50 | 0.0025 | 2.9 | 0.6 | 0.01 | 0.0025 | 1.1 | 0.0038 | 0.0022 | 0.0009 | 0.0025 |
| 51 | 0.0025 | 2.9 | 0.6 | 0.01 | 0.0025 | 1.1 | 0.0038 | 0.0022 | 0.0009 | 0.0025 |
| 52 | 0.0025 | 2.9 | 0.6 | 0.01 | 0.0025 | 1.1 | 0.0038 | 0.0022 | 0.0009 | 0.0025 |
| 53 | 0.0025 | 2.9 | 0.6 | 0.01 | 0.0025 | 1.1 | 0.0038 | 0.0022 | 0.0009 | 0.0025 |
| 54 | 0.0025 | 2.9 | 0.6 | 0.01 | 0.0025 | 1.1 | 0.0038 | 0.0022 | 0.0009 | 0.0025 |
| 55 | 0.0025 | 2.9 | 0.6 | 0.01 | 0.0025 | 1.1 | 0.0038 | 0.0022 | 0.0009 | 0.0025 |
| 56 | 0.0025 | 2.9 | 0.6 | 0.01 | 0.0025 | 1.1 | 0.0038 | 0.0022 | 0.0009 | 0.0025 |
| 57 | 0.0025 | 2.9 | 0.6 | 0.01 | 0.0025 | 1.1 | 0.0038 | 0.0022 | 0.0009 | 0.0025 |
| 58 | 0.0025 | 2.9 | 0.6 | 0.01 | 0.0025 | 1.1 | 0.0038 | 0.0022 | 0.0009 | 0.0025 |
| 59 | 0.0025 | 2.9 | 0.6 | 0.01 | 0.0025 | 1.1 | 0.0038 | 0.0022 | 0.0009 | 0.0025 |
| 60 | 0.0025 | 2.9 | 0.6 | 0.01 | 0.0025 | 1.1 | 0.0038 | 0.0022 | 0.0009 | 0.0025 |

| | Ingredient composition (mass %) | | | | | | | | |
|---|---|---|---|---|---|---|---|---|---|
| No. | N | Sn | Sb | Cu | Cr | Ni | Ca | Mg | REM |
| 41 | 0.0027 | 0.03 | — | — | — | — | — | — | — |
| 42 | 0.0027 | 0.03 | — | — | — | — | — | — | — |
| 43 | 0.0027 | 0.03 | — | — | — | — | — | — | — |
| 44 | 0.0023 | 0.04 | — | — | — | — | — | — | — |
| 45 | 0.0026 | 0.04 | — | — | — | — | — | — | — |
| 46 | 0.0032 | 0.03 | — | — | — | — | — | — | — |
| 47 | 0.0032 | 0.03 | — | 0.04 | — | — | — | — | — |
| 48 | 0.0032 | 0.03 | — | 0.2 | — | — | — | — | — |
| 49 | 0.0032 | 0.03 | — | 0.5 | — | — | — | — | — |
| 50 | 0.0032 | 0.03 | — | 0.8 | — | — | — | — | — |
| 51 | 0.0032 | 0.03 | — | — | 0.04 | — | — | — | — |
| 52 | 0.0032 | 0.03 | — | — | 0.2 | — | — | — | — |
| 53 | 0.0032 | 0.03 | — | — | 0.5 | — | — | — | — |
| 54 | 0.0032 | 0.03 | — | — | 0.8 | — | — | — | — |
| 55 | 0.0032 | 0.03 | — | — | — | 0.04 | — | — | — |
| 56 | 0.0032 | 0.03 | — | — | — | 0.2 | — | — | — |
| 57 | 0.0032 | 0.03 | — | — | — | 0.5 | — | — | — |
| 58 | 0.0032 | 0.03 | — | — | — | 0.8 | — | — | — |
| 59 | 0.0032 | 0.03 | — | 0.1 | 0.1 | 0.1 | — | — | — |
| 60 | 0.0032 | 0.03 | — | 0.3 | — | 0.3 | — | — | — |

TABLE 1-4

| | Ingredient composition (mass %) | | | | | | | | | |
|---|---|---|---|---|---|---|---|---|---|---|
| No. | C | Si | Mn | P | S | Al | Co | Ti | Nb | O |
| 61 | 0.0025 | 2.9 | 0.6 | 0.01 | 0.0025 | 1.1 | 0.0038 | 0.0022 | 0.0009 | 0.0025 |
| 62 | 0.0025 | 2.9 | 0.6 | 0.01 | 0.0025 | 1.1 | 0.0038 | 0.0022 | 0.0009 | 0.0025 |
| 63 | 0.0074 | 3.5 | 0.4 | 0.01 | 0.0019 | 0.8 | 0.0011 | 0.0011 | 0.0009 | 0.0024 |
| 64 | 0.0025 | 3.3 | 0.04 | 0.01 | 0.0024 | 0.7 | 0.0045 | 0.0008 | 0.0011 | 0.0021 |
| 65 | 0.0025 | 2.7 | 0.5 | 0.01 | 0.0019 | 0.2 | 0.0029 | 0.0013 | 0.0011 | 0.0025 |
| 66 | 0.0025 | 3.5 | 0.4 | 0.01 | 0.0019 | 0.8 | 0.0031 | 0.0011 | 0.0009 | 0.0024 |
| 67 | 0.0025 | 3.5 | 0.4 | 0.01 | 0.0019 | 0.8 | 0.0031 | 0.0011 | 0.0009 | 0.0024 |
| 68 | 0.0025 | 3.5 | 0.4 | 0.01 | 0.0019 | 0.8 | 0.0031 | 0.0011 | 0.0009 | 0.0024 |
| 69 | 0.0025 | 3.5 | 0.4 | 0.01 | 0.0019 | 0.8 | 0.0031 | 0.0011 | 0.0009 | 0.0024 |
| 70 | 0.0028 | 3.2 | 0.8 | 0.01 | 0.0024 | 1.8 | 0.0024 | 0.0008 | 0.0012 | 0.0021 |
| 71 | 0.0028 | 3.2 | 0.8 | 0.01 | 0.0024 | 1.8 | 0.0024 | 0.0008 | 0.0012 | 0.0021 |
| 72 | 0.0028 | 3.2 | 0.8 | 0.01 | 0.0024 | 1.8 | 0.0024 | 0.0008 | 0.0012 | 0.0021 |
| 73 | 0.0028 | 3.2 | 0.8 | 0.01 | 0.0024 | 1.8 | 0.0024 | 0.0008 | 0.0012 | 0.0021 |
| 74 | 0.0028 | 3.2 | 0.8 | 0.01 | 0.0024 | 1.2 | 0.0024 | 0.0008 | 0.0012 | 0.0021 |
| 75 | 0.0028 | 3.2 | 0.8 | 0.01 | 0.0024 | 1.2 | 0.0024 | 0.0008 | 0.0012 | 0.0021 |

| | Ingredient composition (mass %) | | | | | | | | |
|---|---|---|---|---|---|---|---|---|---|
| No. | N | Sn | Sb | Cu | Cr | Ni | Ca | Mg | REM |
| 61 | 0.0032 | 0.03 | — | — | 0.3 | 0.3 | — | — | — |
| 62 | 0.0032 | 0.03 | — | 0.3 | 0.3 | 0.3 | — | — | — |
| 63 | 0.0027 | 0.03 | — | — | — | — | — | — | — |
| 64 | 0.0021 | — | — | — | — | — | — | — | — |
| 65 | 0.0024 | — | — | — | — | — | — | — | — |
| 66 | 0.0027 | 0.03 | — | — | — | — | — | — | — |
| 67 | 0.0027 | 0.03 | — | — | — | — | — | — | — |
| 68 | 0.0027 | 0.03 | — | — | — | — | — | — | — |
| 69 | 0.0027 | 0.03 | — | — | — | — | — | — | — |
| 70 | 0.0020 | 0.03 | — | — | — | — | — | — | — |
| 71 | 0.0020 | 0.03 | — | — | — | — | — | — | — |
| 72 | 0.0020 | 0.03 | — | — | — | — | — | — | — |
| 73 | 0.0020 | 0.03 | — | — | — | — | — | — | — |
| 74 | 0.0019 | 0.03 | — | — | — | — | — | — | — |
| 75 | 0.0019 | 0.03 | — | — | — | — | — | — | — |

TABLE 1-5

| | Ingredient composition (mass %) | | | | | | | | | |
|---|---|---|---|---|---|---|---|---|---|---|
| No. | C | Si | Mn | P | S | Al | Co | Ti | Nb | O |
| 76 | 0.005 | 2.0 | 0.15 | 0.006 | 0.0008 | 1.5 | 0.0043 | 0.0030 | 0.0002 | 0.0011 |
| 77 | 0.0032 | 2.2 | 0.05 | 0.004 | 0.0014 | 0.8 | 0.0024 | 0.0005 | 0.0030 | 0.0015 |
| 78 | 0.0036 | 6.5 | 0.1 | 0.01 | 0.0013 | 0.4 | 0.0032 | 0.0008 | 0.0005 | 0.0050 |
| 79 | 0.0021 | 3.5 | 2.0 | 0.10 | 0.0004 | 0.5 | 0.0013 | 0.0011 | 0.0008 | 0.0005 |
| 80 | 0.0023 | 3.5 | 0.5 | 0.05 | 0.0050 | 0.5 | 0.0013 | 0.0012 | 0.0009 | 0.0018 |
| 81 | 0.0022 | 3.8 | 0.5 | 0.02 | 0.0019 | 2.0 | 0.010 | 0.0013 | 0.0009 | 0.0016 |

| | Ingredient composition (mass %) | | | | | | | | |
|---|---|---|---|---|---|---|---|---|---|
| No. | N | Sn | Sb | Cu | Cr | Ni | Ca | Mg | REM |
| 76 | 0.0010 | — | — | — | — | — | — | — | — |
| 77 | 0.0025 | — | — | — | — | — | — | — | — |
| 78 | 0.0011 | — | — | — | — | — | — | — | — |
| 79 | 0.0012 | — | — | — | — | — | — | — | — |
| 80 | 0.0050 | — | — | — | — | — | — | — | — |
| 81 | 0.0023 | — | — | — | — | — | — | — | — |

TABLE 1-6

| | Ingredient composition (mass %) | | | | | | | | | |
|---|---|---|---|---|---|---|---|---|---|---|
| No. | C | Si | Mn | P | S | Al | Co | Ti | Nb | O |
| 82 | 0.0025 | 3.5 | 0.4 | 0.01 | 0.002 | 0.8 | 0.0031 | 0.001 | 0.0009 | 0.002 |
| 83 | 0.0025 | 3.5 | 0.4 | 0.01 | 0.002 | 0.8 | 0.0031 | 0.001 | 0.0009 | 0.002 |
| 84 | 0.0025 | 3.5 | 0.4 | 0.01 | 0.002 | 0.8 | 0.0031 | 0.001 | 0.0009 | 0.002 |
| 85 | 0.0025 | 3.5 | 0.4 | 0.0 | 0.002 | 0.8 | 0.0031 | 0.001 | 0.0009 | 0.002 |
| 86 | 0.0025 | 3.5 | 0.4 | 0.01 | 0.002 | 0.8 | 0.0031 | 0.001 | 0.0009 | 0.002 |
| 87 | 0.0025 | 3.5 | 0.4 | 0.01 | 0.002 | 0.8 | 0.0031 | 0.001 | 0.0009 | 0.002 |
| 88 | 0.0025 | 3.5 | 0.4 | 0.01 | 0.002 | 0.8 | 0.0031 | 0.001 | 0.0009 | 0.002 |
| 89 | 0.0025 | 3.5 | 0.4 | 0.01 | 0.002 | 0.8 | 0.0031 | 0.001 | 0.0009 | 0.002 |
| 90 | 0.0025 | 3.5 | 0.4 | 0.01 | 0.002 | 0.8 | 0.0031 | 0.001 | 0.0009 | 0.002 |
| 91 | 0.0025 | 3.5 | 0.4 | 0.01 | 0.002 | 0.8 | 0.0031 | 0.001 | 0.0009 | 0.002 |
| 92 | 0.0025 | 3.5 | 0.4 | 0.01 | 0.002 | 0.8 | 0.0031 | 0.001 | 0.0009 | 0.002 |
| 93 | 0.0025 | 3.5 | 0.4 | 0.01 | 0.002 | 0.8 | 0.0031 | 0.001 | 0.0009 | 0.002 |
| 94 | 0.0025 | 3.5 | 0.4 | 0.01 | 0.002 | 0.8 | 0.0031 | 0.001 | 0.0009 | 0.002 |
| 95 | 0.0025 | 3.5 | 0.4 | 0.01 | 0.002 | 0.8 | 0.0031 | 0.001 | 0.0009 | 0.002 |
| 96 | 0.0025 | 3.5 | 0.4 | 0.01 | 0.002 | 0.8 | 0.0031 | 0.001 | 0.0009 | 0.002 |
| 97 | 0.0021 | 4.1 | 0.5 | 0.01 | 0.002 | 0.7 | 0.0024 | 0.001 | 0.0013 | 0.002 |
| 98 | 0.0021 | 4.1 | 0.5 | 0.01 | 0.002 | 0.7 | 0.0024 | 0.001 | 0.0013 | 0.002 |
| 99 | 0.0021 | 4.1 | 0.5 | 0.01 | 0.002 | 0.7 | 0.0024 | 0.001 | 0.0013 | 0.002 |
| | Ingredient composition (mass %) | | | | | | | | | |
| No. | N | Sn | Sb | Cu | Cr | Ni | Ca | Mg | REM | Others |
| 82 | 0.0027 | 0.03 | — | — | — | — | — | — | — | Zn:0.0015 |
| 83 | 0.0027 | 0.03 | — | — | — | — | — | — | — | Zn:0.0045 |
| 84 | 0.0027 | 0.03 | — | — | — | — | — | — | — | Zn:0.021 |
| 85 | 0.0027 | 0.03 | — | — | — | — | — | — | — | Mo:0.0029 |
| 86 | 0.0027 | 0.03 | — | — | — | — | — | — | — | Mo:0.0300 |
| 87 | 0.0027 | 0.03 | — | — | — | — | — | — | — | Zn:0.0068 |
| | | | | | | | | | | Mo:0.0050 |
| 88 | 0.0027 | 0.03 | — | — | — | — | — | — | — | W:0.0011 |
| 89 | 0.0027 | 0.03 | — | — | — | — | — | — | — | W:0.014 |
| 90 | 0.0027 | 0.03 | — | — | — | — | — | — | — | W:0.036 |
| 91 | 0.0027 | 0.03 | — | — | — | — | — | — | — | Ga:0.0012 |
| 92 | 0.0027 | 0.03 | — | — | — | — | — | — | — | Ge:0.0024 |
| 93 | 0.0027 | 0.03 | — | — | — | — | — | — | — | Ga:0.0034 |
| | | | | | | | | | | Ge:0.0042 |
| 94 | 0.0027 | 0.03 | — | — | — | — | — | — | — | Ga:0.0067 |
| 95 | 0.0027 | 0.03 | — | — | — | — | — | — | — | Ge:0.081 |
| 96 | 0.0027 | 0.03 | — | — | — | — | — | — | — | Ga:0.0008 |
| | | | | | | | | | | Ge:0.0007 |
| 97 | 0.0022 | 0.03 | — | — | — | — | — | — | — | AS:0.0003 |
| 98 | 0.0022 | 0.03 | — | — | — | — | — | — | — | AS:0.0025 |
| 99 | 0.0022 | 0.03 | — | — | — | — | — | — | — | AS:0.0048 |

TABLE 1-7

| | Ingredient Composition (mass %) | | | | | | | | | |
|---|---|---|---|---|---|---|---|---|---|---|
| No. | C | Si | Mn | P | S | Al | Co | Ti | Nb | O |
| 100 | 0.0021 | 4.1 | 0.5 | 0.01 | 0.002 | 0.7 | 0.0024 | 0.001 | 0.0013 | 0.002 |
| 101 | 0.0021 | 4.1 | 0.5 | 0.01 | 0.002 | 0.7 | 0.0024 | 0.001 | 0.0013 | 0.002 |
| 102 | 0.0021 | 4.1 | 0.5 | 0.01 | 0.002 | 0.7 | 0.0024 | 0.001 | 0.0013 | 0.002 |
| 103 | 0.0021 | 4.1 | 0.5 | 0.01 | 0.002 | 0.7 | 0.0024 | 0.001 | 0.0013 | 0.002 |
| 104 | 0.0021 | 4.1 | 0.5 | 0.01 | 0.002 | 0.7 | 0.0024 | 0.001 | 0.0013 | 0.002 |
| 105 | 0.0021 | 4.1 | 0.5 | 0.01 | 0.002 | 0.7 | 0.0024 | 0.001 | 0.0013 | 0.002 |
| 106 | 0.0021 | 4.1 | 0.5 | 0.01 | 0.002 | 0.7 | 0.0024 | 0.001 | 0.0013 | 0.002 |
| 107 | 0.0021 | 4.1 | 0.5 | 0.01 | 0.002 | 0.7 | 0.0024 | 0.001 | 0.0013 | 0.002 |
| 108 | 0.0021 | 4.1 | 0.5 | 0.01 | 0.002 | 0.7 | 0.0024 | 0.001 | 0.0013 | 0.002 |
| 109 | 0.0021 | 4.1 | 0.5 | 0.01 | 0.002 | 0.7 | 0.0024 | 0.001 | 0.0013 | 0.002 |
| 110 | 0.0021 | 4.1 | 0.5 | 0.01 | 0.002 | 0.7 | 0.0024 | 0.001 | 0.0013 | 0.002 |
| 111 | 0.0021 | 4.1 | 0.5 | 0.01 | 0.002 | 0.7 | 0.0024 | 0.001 | 0.0013 | 0.002 |
| 112 | 0.0021 | 4.1 | 0.5 | 0.01 | 0.002 | 0.7 | 0.0024 | 0.001 | 0.0013 | 0.002 |
| | Ingredient Composition (mass %) | | | | | | | | | |
| No. | N | Sn | Sb | Cu | Cr | Ni | Ca | Mg | REM | Others |
| 100 | 0.0022 | 0.03 | — | — | — | — | — | — | — | As:0.0091 |
| 101 | 0.0022 | 0.03 | — | — | — | — | — | — | — | B:0.0002 |
| 102 | 0.0022 | 0.03 | — | — | — | — | — | — | — | B:0.0015 |
| 103 | 0.0022 | 0.03 | — | — | — | — | — | — | — | B:0.0045 |
| 104 | 0.0022 | 0.03 | — | — | — | — | — | — | — | V:0.0001 |
| 105 | 0.0022 | 0.03 | — | — | — | — | — | — | — | V:0.0011 |
| 106 | 0.0022 | 0.03 | — | — | — | — | — | — | — | V:0.0038 |
| 107 | 0.0022 | 0.03 | — | — | — | — | — | — | — | Pb:0.0004 |
| 108 | 0.0022 | 0.03 | — | — | — | — | — | — | — | Pb:0.0012 |
| 109 | 0.0022 | 0.03 | — | — | — | — | — | — | — | Pb:0.0045 |
| 110 | 0.0022 | 0.03 | — | — | — | — | — | — | — | As:0.021 |
| | | | | | | | | | | B:0.0001 |
| | | | | | | | | | | V:0.0015 |
| | | | | | | | | | | Pb:0.0012 |
| 111 | 0.0022 | 0.03 | — | — | — | — | — | — | — | As:0.0026 |
| | | | | | | | | | | Pb:0.0018 |
| 112 | 0.0022 | 0.03 | — | — | — | — | — | — | — | As:0.0019 |
| | | | | | | | | | | V:0.0023 |
| | | | | | | | | | | Pb:0.0014 |

TABLE 2-1

| | | | | | | | Finishing |
|---|---|---|---|---|---|---|---|
| | | | | | | | annealing |
| | Cold | | | | | | conditions |
| | rolling | Conditions of electrolytic alkali treatment | | | | | Dew |
| | Final | before finishing annealing | | | | | point |
| Steel | sheet | | Charge | | | | (°C) of |
| type | thickness | | density | Concentration | Temp. | Time | rapid |
| No. | (mm) | Liquid type | (C/dm²) | (%) | (°C) | (sec) | heating |
| 1 | 0.25 | Sodium hydroxide | 4 | 5 | 70 | 5 | −68 |
| 2 | 0.25 | Sodium hydroxide | 3 | 5 | 70 | 5 | −55 |
| 3 | 0.25 | Sodium hydroxide | 6 | 5 | 70 | 5 | −60 |
| 4 | 0.25 | Sodium hydroxide | 9 | 5 | 70 | 5 | −45 |
| 5 | 0.25 | Sodium hydroxide | 12 | 5 | 70 | 5 | −40 |
| 6 | 0.25 | Sodium hydroxide | 12 | 5 | 70 | 5 | −40 |
| 7 | 0.30 | Sodium hydroxide | 4 | 10 | 70 | 3 | −40 |
| 8 | 0.30 | Sodium hydroxide | 5 | 13 | 70 | 15 | −40 |
| 9 | 0.30 | Sodium hydroxide | 5 | 0.5 | 70 | 10 | −40 |
| 10 | 0.30 | Sodium hydroxide | 5 | 8 | 90 | 20 | −40 |
| 11 | 0.30 | Sodium hydroxide | 5 | 3 | 85 | 3 | −35 |
| 12 | 0.27 | Sodium hydroxide | 5 | 3 | 85 | 3 | −35 |
| 13 | 0.25 | Sodium hydroxide | 5 | 3 | 85 | 3 | −35 |
| 14 | — | — | — | — | — | — | — |
| 15 | — | — | — | — | — | — | — |
| 16 | 0.25 | Potassium | 7 | 7 | 50 | 5 | −30 |
| | | hydroxide | | | | | |
| 17 | 0.25 | Potassium | 7 | 7 | 50 | 5 | −30 |
| | | hydroxide | | | | | |
| 18 | — | — | — | — | — | — | — |
| 19 | 0.35 | Calcium hydroxide | 8 | 3 | 90 | 12 | −40 |
| 20 | 0.20 | Calcium hydroxide | 8 | 3 | 90 | 12 | −40 |
| | Finishing | | | | | | |
| | annealing | | | | | | |
| | conditions | Nitrogen | | | Thickness | | |
| | Conditions | amount | | | (nm) of | Al | |
| | of | in surface | | | oxide film | concentration | |
| Steel | radiation | layer | (N as | Iron loss | on | of oxide | |
| type | heating | N as AlN | AlN)/ | W17/50 | surface | film | |
| No. | (°C × sec) | (mass %) | Nc | (W/kg) | layer | (at %) | Remarks |
| 1 | 1000 × 10 | 0.0039 | 1.4 | 2.80 | 10 | 9 | Invention Example |
| 2 | 1000 × 10 | 0.0038 | 1.4 | 2.75 | 20 | 8 | Invention Example |
| 3 | 1000 × 10 | 0.0035 | 1.3 | 2.68 | 15 | 11 | Invention Example |
| 4 | 1000 × 10 | 0.0034 | 1.3 | 2.70 | 5 | 10 | Invention Example |
| 5 | 1000 × 10 | 0.0094 | 3.5 | 3.45 | 10 | 10 | Comparative Example |
| 6 | 1000 × 10 | 0.004 | 1.7 | 3.40 | 20 | 10 | Comparative Example |
| 7 | 1000 × 10 | 0.0035 | 1.5 | 2.77 | 10 | 9 | Invention Example |
| 8 | 1000 × 10 | 0.0041 | 1.7 | 2.61 | 45 | 12 | Invention Example |
| 9 | 1000 × 10 | 0.0098 | 4.1 | 3.55 | 3 | 6 | Comparative Example |
| 10 | 1000 × 10 | 0.0099 | 4.1 | 3.56 | 65 | 7 | Comparative Example |
| 11 | 1050 × 10 | 0.0035 | 1.5 | 2.65 | 15 | 10 | Invention Example |
| 12 | 1050 × 10 | 0.0038 | 2.0 | 2.62 | 20 | 10 | Invention Example |
| 13 | 1050 × 10 | 0.0036 | 1.8 | 2.61 | 20 | 10 | Invention Example |
| 14 | — | — | — | — | — | — | Comparative Example |
| 15 | — | — | — | — | — | — | Comparative Example |
| 16 | 980 × 10 | 0.0039 | 1.4 | 2.59 | 10 | 13 | Invention Example |
| 17 | 980 × 10 | 0.0038 | 1.4 | 2.59 | 15 | 13 | Invention Example |
| 18 | — | — | — | — | — | — | Comparative Example |
| 19 | 960 × 10 | 0.0036 | 1.5 | 2.65 | 20 | 12 | Invention Example |
| 20 | 960 × 10 | 0.0035 | 1.5 | 2.64 | 20 | 12 | Invention Example |

TABLE 2-2

| | | | | | | | Finishing |
|---|---|---|---|---|---|---|---|
| | | | | | | | annealing |
| | Cold | | | | | | conditions |
| | rolling | Conditions of electrolytic alkali treatment | | | | | Dew |
| | Final | before finishing annealing | | | | | point |
| Steel | sheet | | Charge | | | | (°C) of |
| type | thickness | | density | Concentration | Temp. | Time | rapid |
| No. | (mm) | Liquid type | (C/dm²) | (%) | (°C) | (sec) | heating |
| 21 | — | — | — | — | — | — | — |
| 22 | 0.25 | Sodium orthosilicate | 3 | 5 | 30 | 30 | −20 |
| 23 | 0.25 | Sodium orthosilicate | 3 | 5 | 30 | 30 | −20 |
| 24 | 0.27 | Sodium orthosilicate | 3 | 3 | 50 | 50 | −20 |
| 25 | 0.25 | Potassium hydroxide | 5 | 8 | 70 | 20 | −20 |
| 26 | 0.25 | Potassium hydroxide | 5 | 10 | 100 | 10 | −30 |
| 27 | 0.25 | Potassium hydroxide | 5 | 10 | 20 | 10 | −30 |
| 28 | 0.25 | Potassium hydroxide | 6 | 7 | 80 | 5 | −40 |
| 29 | 0.25 | Potassium hydroxide | 6 | 7 | 80 | 5 | −40 |
| 30 | 0.25 | Potassium hydroxide | 6 | 7 | 80 | 5 | −40 |
| 31 | 0.25 | Potassium hydroxide | 6 | 7 | 80 | 5 | −40 |
| 32 | 0.25 | Potassium hydroxide | 6 | 7 | 80 | 5 | −40 |
| 33 | 0.20 | Sodium hydroxide | 6 | 3 | 90 | 4 | −10 |
| 34 | 0.25 | Sodium hydroxide | 6 | 3 | 90 | 4 | −10 |
| 35 | 0.30 | Sodium hydroxide | 6 | 3 | 90 | 4 | −10 |
| 36 | 0.15 | Sodium hydroxide | 6 | 3 | 90 | 4 | −10 |
| 37 | 0.20 | Sodium hydroxide | 10 | 3 | 90 | 4 | −10 |
| 38 | 0.25 | Sodium hydroxide | 10 | 5 | 80 | 4 | −10 |
| 39 | 0.25 | Sodium hydroxide | 10 | 5 | 80 | 4 | −10 |
| 40 | 0.35 | Sodium hydroxide | 10 | 1 | 85 | 1 | −55 |
| | Finishing | | | | | | |
| | annealing | | | | | | |
| | conditions | Nitrogen | | | Thickness | | |
| | Conditions | amount | | | (nm) of | Al | |
| | of | in surface | | | oxide film | concentration | |
| Steel | radiation | layer | (N as | Iron loss | on | of oxide | |
| type | heating | N as AlN | AlN)/ | W17/50 | surface | film | |
| No. | (°C × sec) | (mass %) | Nc | (W/kg) | layer | (at %) | Remarks |
| 21 | — | — | — | — | — | — | Comparative Example |
| 22 | 1000 × 10 | 0.0041 | 2.0 | 2.92 | 15 | 8 | Invention Example |
| 23 | 1000 × 10 | 0.0040 | 1.9 | 2.91 | 15 | 8 | Invention Example |
| 24 | 1000 × 10 | 0.0045 | 2.1 | 2.85 | 35 | 8 | Invention Example |
| 25 | 1000 × 10 | 0.0041 | 2.0 | 2.78 | 30 | 10 | Invention Example |
| 26 | 1020 × 10 | 0.0035 | 1.7 | 2.71 | 25 | 10 | Invention Example |
| 27 | 1020 × 10 | 0.0035 | 1.7 | 2.72 | 20 | 10 | Invention Example |
| 28 | 960 × 10 | 0.0044 | 1.7 | 3.55 | 15 | 10 | Comparative Example |
| 29 | 960 × 10 | 0.0041 | 1.6 | 3.65 | 15 | 10 | Comparative Example |
| 30 | 960 × 10 | 0.0042 | 1.6 | 3.71 | 15 | 10 | Comparative Example |
| 31 | 960 × 10 | 0.0041 | 1.6 | 3.48 | 15 | 10 | Comparative Example |
| 32 | 960 × 10 | 0.05 | 4.5 | 3.85 | 15 | 10 | Comparative Example |
| 33 | 1000 × 10 | 0.0039 | 1.8 | 2.61 | 20 | 13 | Invention Example |
| 34 | 1000 × 10 | 0.0038 | 1.7 | 2.60 | 20 | 13 | Invention Example |
| 35 | 1000 × 10 | 0.0038 | 1.7 | 2.60 | 25 | 14 | Invention Example |
| 36 | 1000 × 10 | 0.0033 | 1.4 | 2.58 | 25 | 14 | Invention Example |
| 37 | 1000 × 10 | 0.0032 | 1.4 | 2.57 | 25 | 14 | Invention Example |
| 38 | 1000 × 10 | 0.0032 | 1.4 | 2.55 | 25 | 14 | Invention Example |
| 39 | 1000 × 10 | 0.0032 | 1.0 | 2.55 | 25 | 14 | Invention Example |
| 40 | 1000 × 10 | 0.0043 | 1.6 | 2.99 | 30 | 15 | Invention Example |

TABLE 2-3

| | | | | | | | Finishing |
|---|---|---|---|---|---|---|---|
| | | | | | | | annealing |
| | Cold | | | | | | conditions |
| | rolling | Conditions of electrolytic alkali treatment before | | | | | Dew |
| | Final | finishing annealing | | | | | point |
| Steel | sheet | | Charge | | | | (°C) of |
| type | thickness | | density | Concentration | Temp. | Time | rapid |
| No. | (mm) | Liquid type | (C/dm²) | (%) | (°C) | (sec) | heating |
| 41 | 0.35 | Sodium hydroxide | 10 | 1 | 85 | 15 | −55 |
| 42 | 0.35 | Sodium hydroxide | 10 | 10 | 85 | 1 | −55 |
| 43 | 0.35 | Sodium hydroxide | 10 | 10 | 85 | 15 | −55 |
| 44 | 0.50 | Sodium hydroxide | 11 | 3 | 90 | 3 | −55 |
| 45 | 0.50 | Sodium hydroxide | 11 | 3 | 90 | 3 | −55 |
| 46 | 0.30 | Sodium hydroxide | 11 | 4 | 95 | 5 | −55 |
| 47 | 0.30 | Sodium hydroxide | 11 | 4 | 95 | 5 | −55 |
| 48 | 0.30 | Sodium hydroxide | 5 | 4 | 95 | 5 | −55 |
| 49 | 0.30 | Sodium hydroxide | 5 | 4 | 95 | 5 | −55 |
| 50 | 0.30 | Sodium hydroxide | 5 | 4 | 95 | 5 | −55 |
| 51 | 0.30 | Sodium hydroxide | 5 | 4 | 95 | 5 | −55 |
| 52 | 0.30 | Sodium hydroxide | 5 | 4 | 95 | 5 | −55 |
| 53 | 0.30 | Sodium hydroxide | 5 | 4 | 95 | 5 | −55 |
| 54 | 0.30 | Sodium hydroxide | 5 | 4 | 95 | 5 | −55 |
| 55 | 0.30 | Sodium hydroxide | 5 | 4 | 95 | 5 | −55 |
| 56 | 0.30 | Sodium hydroxide | 5 | 4 | 95 | 5 | −55 |
| 57 | 0.30 | Sodium hydroxide | 5 | 4 | 95 | 5 | −55 |
| 58 | 0.30 | Sodium hydroxide | 5 | 4 | 95 | 5 | −55 |
| 59 | 0.30 | Sodium hydroxide | 5 | 4 | 95 | 5 | −55 |
| 60 | 0.30 | Sodium hydroxide | 5 | 4 | 95 | 5 | −55 |
| | Finishing | | | | | | |
| | annealing | | | | | | |
| | conditions | Nitrogen | | | Thickness | | |
| | Conditions | amount | | | (nm) of | Al | |
| | of | in surface | | | oxide film | concentration | |
| Steel | radiation | layer | (N as | Iron loss | on | of oxide | |
| type | heating | N as AlN | AlN)/ | W17/50 | surface | film | |
| No. | (°C × sec) | (mass %) | Nc | (W/kg) | layer | (at %) | Remarks |
| 41 | 1000 × 10 | 0.0042 | 1.6 | 2.98 | 25 | 14 | Invention Example |
| 42 | 1000 × 10 | 0.0041 | 1.5 | 2.96 | 20 | 13 | Invention Example |
| 43 | 1000 × 10 | 0.0041 | 1.5 | 2.95 | 30 | 15 | Invention Example |
| 44 | 1000 × 10 | 0.0039 | 1.7 | 3.02 | 30 | 9 | Invention Example |
| 45 | 1000 × 10 | 0.0039 | 1.5 | 3.08 | 30 | 9 | Invention Example |
| 46 | 1000 × 10 | 0.0037 | 1.2 | 2.85 | 15 | 9 | Invention Example |
| 47 | 1000 × 10 | 0.0037 | 1.2 | 2.81 | 15 | 9 | Invention Example |
| 48 | 1000 × 10 | 0.0037 | 1.2 | 2.79 | 15 | 10 | Invention Example |
| 49 | 1000 × 10 | 0.0037 | 1.2 | 2.78 | 15 | 10 | Invention Example |
| 50 | 1000 × 10 | 0.0037 | 1.2 | 2.77 | 15 | 10 | Invention Example |
| 51 | 1000 × 10 | 0.0037 | 1.2 | 2.80 | 15 | 10 | Invention Example |
| 52 | 1000 × 10 | 0.0037 | 1.2 | 2.79 | 15 | 10 | Invention Example |
| 53 | 1000 × 10 | 0.0037 | 1.2 | 2.78 | 15 | 10 | Invention Example |
| 54 | 1000 × 10 | 0.0037 | 1.2 | 2.77 | 15 | 10 | Invention Example |
| 55 | 1000 × 10 | 0.0037 | 1.2 | 2.80 | 15 | 10 | Invention Example |
| 56 | 1000 × 10 | 0.0037 | 1.2 | 2.79 | 15 | 10 | Invention Example |
| 57 | 1000 × 10 | 0.0037 | 1.2 | 2.78 | 15 | 10 | Invention Example |
| 58 | 1000 × 10 | 0.0037 | 1.2 | 2.77 | 15 | 10 | Invention Example |
| 59 | 1000 × 10 | 0.0037 | 1.2 | 2.76 | 15 | 10 | Invention Example |
| 60 | 1000 × 10 | 0.0037 | 1.2 | 2.75 | 15 | 10 | Invention Example |

TABLE 2-4

| | | | | | | | Finishing |
|---|---|---|---|---|---|---|---|
| | | | | | | | annealing |
| | Cold | | | | | | conditions |
| | rolling | Conditions of electrolytic alkali treatment | | | | | Dew |
| | Final | before finishing annealing | | | | | point |
| Steel | sheet | | Charge | | | | (°C) of |
| type | thickness | | density | Concentration | Temp. | Time | rapid |
| No. | (mm) | Liquid type | (C/dm²) | (%) | (°C) | (sec) | heating |
| 61 | 0.30 | Sodium hydroxide | 5 | 4 | 95 | 5 | −55 |
| 62 | 0.30 | Sodium hydroxide | 5 | 4 | 95 | 5 | −55 |
| 63 | 0.25 | Sodium hydroxide | 5 | 5 | 70 | 5 | −68 |
| 64 | — | — | — | — | — | — | — |
| 65 | 0.30 | Sodium hydroxide | 5 | 3 | 85 | 3 | −35 |
| 56 | 0.25 | Sodium hydroxide | 2 | 5 | 70 | 5 | −55 |
| 67 | 0.25 | Sodium hydroxide | 13 | 5 | 70 | 5 | −55 |
| 68 | 0.25 | Sodium hydroxide | 5 | 0.7 | 70 | 5 | −55 |
| 69 | 0.25 | Sodium hydroxide | 5 | 11.5 | 70 | 5 | −55 |
| 70 | 0.25 | Sodium hydroxide | 5 | 3 | 25 | 3 | −35 |
| 71 | 0.25 | Sodium hydroxide | 5 | 3 | 125 | 3 | −35 |
| 72 | 0.25 | Sodium hydroxide | 5 | 3 | 85 | 0.5 | −35 |
| 73 | 0.25 | Sodium hydroxide | 5 | 3 | 85 | 17 | −35 |
| 74 | 0.27 | Potassium hydroxide | 5 | 3 | 85 | 5 | −70 |
| 75 | 0.27 | Potassium hydroxide | 3 | 1 | 40 | 3 | −70 |
| | Finishing | | | | | | |
| | annealing | | | | | | |
| | conditions | Nitrogen | | | Thickness | | |
| | Conditions | amount | | | (nm) of | Al | |
| | of | in surface | | | oxide film | concentration | |
| Steel | radiation | layer | (N as | Iron loss | on | of oxide | |
| type | heating | N as AlN | AlN)/ | W17/50 | surface | film | |
| No. | (°C × sec) | (mass %) | Nc | (W/kg) | layer | (at %) | Remarks |
| 61 | 1000 × 10 | 0.0037 | 1.2 | 2.74 | 15 | 10 | Invention Example |
| 62 | 1000 × 10 | 0.0037 | 1.2 | 2.73 | 15 | 10 | Invention Example |
| 63 | 1000 × 10 | 0.01 | 3.7 | 3.47 | 10 | 12 | Comparative Example |
| 64 | 1000 × 10 | — | — | — | — | — | Comparative Example |
| 65 | 1050 × 10 | 0.0097 | 4.0 | 3.58 | 15 | 10 | Comparative Example |
| 56 | 1000 × 10 | 0.0089 | 3.3 | 3.42 | 20 | 6 | Comparative Example |
| 67 | 1000 × 10 | 0.0091 | 3.4 | 3.44 | 20 | 15 | Comparative Example |
| 68 | 1000 × 10 | 0.011 | 4.1 | 3.76 | 20 | 15 | Comparative Example |
| 69 | 1000 × 10 | 0.01 | 3.7 | 3.71 | 20 | 15 | Comparative Example |
| 70 | 1050 × 10 | 0.0076 | 3.8 | 3.72 | 20 | 10 | Comparative Example |
| 71 | 1050 × 10 | 0.0082 | 4.1 | 3.78 | 20 | 10 | Comparative Example |
| 72 | 1050 × 10 | 0.0095 | 4.8 | 3.95 | 20 | 10 | Comparative Example |
| 73 | 1050 × 10 | 0.0087 | 4.4 | 3.83 | 20 | 10 | Comparative Example |
| 74 | 1050 × 10 | 0.0034 | 1.8 | 2.59 | 20 | 13 | Invention Example |
| 75 | 1050 × 10 | 0.0048 | 2.7 | 2.79 | 20 | 8 | Invention Example |

TABLE 2-5

| | | | | | | | Finishing |
|---|---|---|---|---|---|---|---|
| | | | | | | | annealing |
| | Cold | | | | | | conditions |
| | rolling | Conditions of electrolytic alkali treatment | | | | | Dew |
| | Final | before finishing annealing | | | | | point |
| Steel | sheet | | Charge | | | | (°C) of |
| type | thickness | | density | Concentration | Temp. | Time | rapid |
| No. | (mm) | Liquid type | (C/dm²) | (%) | (°C) | (sec) | heating |
| 76 | 0.25 | Sodium hydroxide | 6 | 5 | 70 | 5 | −68 |
| 77 | 0.25 | Sodium hydroxide | 6 | 5 | 70 | 5 | −68 |
| 78 | 0.25 | Sodium hydroxide | 6 | 5 | 70 | 5 | −68 |
| 79 | 0.25 | Sodium hydroxide | 6 | 5 | 70 | 5 | −68 |
| 80 | 0.25 | Sodium hydroxide | 6 | 5 | 70 | 5 | −68 |
| 81 | 0.25 | Sodium hydroxide | 6 | 5 | 70 | 5 | −68 |
| | Finishing | | | | | | |
| | annealing | | | | | | |
| | conditions | Nitrogen | | | Thickness | | |
| | Conditions | amount | | | (nm) of | Al | |
| | of | in surface | | | oxide film | concentration | |
| Steel | radiation | layer | (N as | Iron loss | on | of oxide | |
| type | heating | N as AlN | AlN)/ | W17/50 | surface | film | |
| No. | (°C × sec) | (mass %) | Nc | (W/kg) | layer | (at %) | Remarks |
| 76 | 1030 × 10 | 0.0032 | 3.2 | 2.78 | 15 | 12 | Invention Example |
| 77 | 1030 × 10 | 0.0034 | 1.4 | 2.58 | 15 | 11 | Invention Example |
| 78 | 1030 × 10 | 0.0023 | 2.1 | 2.77 | 15 | 11 | Invention Example |
| 79 | 1030 × 10 | 0.0021 | 1.8 | 2.87 | 15 | 12 | Invention Example |
| 80 | 1030 × 10 | 0.0089 | 1.8 | 2.79 | 15 | 11 | Invention Example |
| 81 | 1030 × 10 | 0.0032 | 1.4 | 2.88 | 15 | 12 | Invention Example |

TABLE 2-6

| | | | | | | | Finishing |
|---|---|---|---|---|---|---|---|
| | | | | | | | annealing |
| | Cold | | | | | | conditions |
| | rolling | Conditions of electrolytic alkali treatment | | | | | Dew |
| | Final | before finishing annealing | | | | | point |
| Steel | sheet | | Charge | | | | (°C) of |
| type | thickness | | density | Concentration | Temp. | Time | rapid |
| No. | (mm) | Liquid type | (C/dm²) | (%) | (°C) | (sec) | heating |
| 82 | 0.25 | Sodium hydroxide | 3 | 5 | 70 | 5 | −55 |
| 83 | 0.25 | Sodium hydroxide | 3 | 5 | 70 | 5 | −55 |
| 84 | 0.25 | Sodium hydroxide | 3 | 5 | 70 | 5 | −55 |
| 85 | 0.25 | Sodium hydroxide | 3 | 5 | 70 | 5 | −55 |
| 86 | 0.25 | Sodium hydroxide | 3 | 5 | 70 | 5 | −55 |
| 87 | 0.25 | Sodium hydroxide | 3 | 5 | 70 | 5 | −55 |
| 88 | 0.25 | Sodium hydroxide | 3 | 5 | 70 | 5 | −55 |
| 89 | 0.25 | Sodium hydroxide | 3 | 5 | 70 | 5 | −55 |
| 90 | 0.25 | Sodium hydroxide | 3 | 5 | 70 | 5 | −55 |
| 91 | 0.25 | Sodium hydroxide | 3 | 5 | 70 | 5 | −55 |
| 92 | 0.25 | Sodium hydroxide | 3 | 5 | 70 | 5 | −55 |
| 93 | 0.25 | Sodium hydroxide | 3 | 5 | 70 | 5 | −55 |
| 94 | 0.25 | Sodium hydroxide | 3 | 5 | 70 | 5 | −55 |
| 95 | 0.25 | Sodium hydroxide | 3 | 5 | 70 | 5 | −55 |
| 96 | 0.25 | Sodium hydroxide | 3 | 5 | 70 | 5 | −55 |
| 97 | 0.30 | Sodium hydroxide | 6 | 3 | 90 | 4 | −10 |
| 98 | 0.30 | Sodium hydroxide | 6 | 3 | 90 | 4 | −10 |
| 99 | 0.30 | Sodium hydroxide | 6 | 3 | 90 | 4 | −10 |
| | Finishing | | | | | | |
| | annealing | | | | | | |
| | conditions | Nitrogen | | | Thickness | | |
| | Conditions | amount | | | (nm) of | Al | |
| | of | in surface | | | oxide film | concentration | |
| Steel | radiation | layer | (N as | Iron loss | on | of oxide | |
| type | heating | N as AlN | AlN)/ | W17/50 | surface | film | |
| No. | (°C × sec) | (mass %) | Nc | (W/kg) | layer | (at %) | Remarks |
| 82 | 1000 × 10 | 0.0036 | 1.3 | 2.72 | 20 | 8 | Invention Example |
| 83 | 1000 × 10 | 0.0034 | 1.3 | 2.70 | 22 | 8 | Invention Example |
| 84 | 1000 × 10 | 0.0032 | 1.2 | 2.68 | 24 | 8 | Invention Example |
| 85 | 1000 × 10 | 0.0035 | 1.3 | 2.72 | 20 | 8 | Invention Example |
| 86 | 1000 × 10 | 0.0034 | 1.3 | 2.71 | 21 | 8 | Invention Example |
| 87 | 1000 × 10 | 0.0035 | 1.3 | 2.72 | 20 | 8 | Invention Example |
| 88 | 1000 × 10 | 0.0034 | 1.3 | 2.71 | 20 | 8 | Invention Example |
| 89 | 1000 × 10 | 0.0035 | 1.3 | 2.72 | 20 | 8 | Invention Example |
| 90 | 1000 × 10 | 0.0034 | 1.3 | 2.70 | 22 | 8 | Invention Example |
| 91 | 1000 × 10 | 0.0036 | 1.3 | 2.74 | 20 | 8 | Invention Example |
| 92 | 1000 × 10 | 0.0036 | 1.3 | 2.74 | 20 | 8 | Invention Example |
| 93 | 1000 × 10 | 0.0035 | 1.3 | 2.73 | 20 | 8 | Invention Example |
| 94 | 1000 × 10 | 0.0034 | 1.3 | 2.70 | 20 | 8 | Invention Example |
| 95 | 1000 × 10 | 0.0035 | 1.3 | 2.72 | 20 | 8 | Invention Example |
| 96 | 1000 × 10 | 0.0035 | 1.3 | 2.71 | 20 | 8 | Invention Example |
| 97 | 1000 × 10 | 0.0037 | 1.7 | 2.58 | 25 | 14 | Invention Example |
| 98 | 1000 × 10 | 0.0036 | 1.6 | 2.57 | 25 | 14 | Invention Example |
| 99 | 1000 × 10 | 0.0035 | 1.6 | 2.57 | 25 | 14 | Invention Example |

TABLE 2-7

| | | | | | | | Finishing |
|---|---|---|---|---|---|---|---|
| | | | | | | | annealing |
| | Cold | | | | | | conditions |
| | rolling | Conditions of electrolytic alkali treatment | | | | | Dew |
| | Final | before finishing annealing | | | | | point |
| Steel | sheet | | Charge | | | | (°C) of |
| type | thickness | | density | Concentration | Temp. | Time | rapid |
| No. | (mm) | Liquid type | (C/dm²) | (%) | (°C) | (sec) | heating |
| 100 | 0.30 | Sodium hydroxide | 6 | 3 | 90 | 4 | −10 |
| 101 | 0.30 | Sodium hydroxide | 6 | 3 | 90 | 4 | −10 |
| 102 | 0.30 | Sodium hydroxide | 6 | 3 | 90 | 4 | −10 |
| 103 | 0.30 | Sodium hydroxide | 6 | 3 | 90 | 4 | −10 |
| 104 | 0.30 | Sodium hydroxide | 6 | 3 | 90 | 4 | −10 |
| 105 | 0.30 | Sodium hydroxide | 6 | 3 | 90 | 4 | −10 |
| 106 | 0.30 | Sodium hydroxide | 6 | 3 | 90 | 4 | −10 |
| 107 | 0.30 | Sodium hydroxide | 6 | 3 | 90 | 4 | −10 |
| 108 | 0.30 | Sodium hydroxide | 6 | 3 | 90 | 4 | −10 |
| 109 | 0.30 | Sodium hydroxide | 6 | 3 | 90 | 4 | −10 |
| 110 | 0.30 | Sodium hydroxide | 6 | 3 | 90 | 4 | −10 |
| 111 | 0.30 | Sodium hydroxide | 6 | 3 | 90 | 4 | −10 |
| 112 | 0.30 | Sodium hydroxide | 6 | 3 | 90 | 4 | −10 |
| | Finishing | | | | | | |
| | annealing | | | | | | |
| | conditions | Nitrogen | | | Thickness | | |
| | Conditions | amount | | | (nm) of | Al | |
| | of | in surface | | | oxide film | concentration | |
| Steel | radiation | layer | (N as | Iron loss | on | of oxide | |
| type | heating | N as AlN | AlN)/ | W17/50 | surface | film | |
| No. | (°C × sec) | (mass %) | Nc | (W/kg) | layer | (at %) | Remarks |
| 100 | 1000 × 10 | 0.0035 | 1.6 | 2.56 | 25 | 14 | Invention Example |
| 101 | 1000 × 10 | 0.0037 | 1.7 | 2.59 | 25 | 14 | Invention Example |
| 102 | 1000 × 10 | 0.0037 | 1.7 | 2.59 | 25 | 14 | Invention Example |
| 103 | 1000 × 10 | 0.0037 | 1.7 | 2.58 | 25 | 14 | Invention Example |
| 104 | 1000 × 10 | 0.0037 | 1.7 | 2.58 | 25 | 14 | Invention Example |
| 105 | 1000 × 10 | 0.0036 | 1.6 | 2.57 | 25 | 14 | Invention Example |
| 106 | 1000 × 10 | 0.0035 | 1.6 | 2.55 | 25 | 14 | Invention Example |
| 107 | 1000 × 10 | 0.0037 | 1.7 | 2.58 | 25 | 14 | Invention Example |
| 108 | 1000 × 10 | 0.0035 | 1.6 | 2.56 | 25 | 14 | Invention Example |
| 109 | 1000 × 10 | 0.0034 | 1.5 | 2.54 | 25 | 14 | Invention Example |
| 110 | 1000 × 10 | 0.0033 | 1.5 | 2.53 | 25 | 14 | Invention Example |
| 111 | 1000 × 10 | 0.0034 | 1.5 | 2.55 | 25 | 14 | Invention Example |
| 112 | 1000 × 10 | 0.0033 | 1.5 | 2.53 | 25 | 14 | Invention Example |

1. A non-oriented electrical steel sheet characterized in that:
the non-oriented electrical steel sheet has an ingredient composition containing, in mass %,
C: 0.0050% or less,
Si: 2.0 to 6.5%,
Mn: 0.05 to 2.00%,
P: 0.10% or less,
S: 0.0050% or less,
Al: 0.3 to 2.0%,
N: 0.0010 to 0.0050%,
Co: 0.0010 to 0.010%,
Ti: 0.0030% or less,
Nb: 0.0030% or less, and
O: 0.0050% or less,
with the balance being composed of Fe and unavoidable impurities;
the non-oriented electrical steel sheet has an oxide layer containing Si, Al, and Co on a surface of the steel sheet on at least one side;
an amount of nitrogen (NasAlN) in a steel sheet surface layer that is present as AlN in a layer from the surface of the steel sheet to 1/20 of a sheet thickness is 0.01 mass % or less;
an amount of nitrogen Nc at a central portion of the steel sheet in the sheet thickness and the amount of nitrogen (NasAlN) in the steel sheet surface layer meet the following Formula (1):
(NasAlN)/Nc≤3.0 (1); and
an iron loss value of the steel sheet excited at 50 Hz and 1.7 T is 3.2 W/kg or less.

2. The non-oriented electrical steel sheet according to claim 1, wherein
an Al concentration in the oxide layer provided on the surface of the steel sheet is 10 at % or higher.

3. The non-oriented electrical steel sheet according to claim 1, wherein
the steel sheet further contains, in addition to the ingredient composition, an ingredient or ingredients of one or more groups among the following groups A to C, in mass %:
group A: one type or two types selected from Sn: 0.005 to 0.20% and Sb: 0.005 to 0.20%,
group B: one type or two or more types selected from Cu, Ni, and Cr: 0.03 to 1.0% in total, and
group C: one type or two or more types selected from Ca, Mg, and REM: 0.0005 to 0.020% in total.

4. The non-oriented electrical steel sheet according to claim 1, wherein
the steel sheet further contains, in addition to the ingredient composition, an ingredient or ingredients of one or more groups among the following groups D to G, in mass %:
group D: one type or two types selected from Ge and Ga: 0.0005 to 0.01% in total,
group E: Zn: 0.001 to 0.05%,
group F: one type or two or more types selected from Mo, As, and W: 0.001 to 0.05% in total, and
group G: one type or two or more types selected from B, Pb, and V: 0.0001 to 0.01% in total.

5. A production method of a non-oriented electrical steel sheet characterized by comprising:
a hot rolling step of hot-rolling a steel slab into a hot-rolled sheet, the steel slab having an ingredient composition containing, in mass %,
C: 0.0050% or less,
Si: 2.0 to 6.5%,
Mn: 0.05 to 2.00%,
P: 0.10% or less,
S: 0.0050% or less,
Al: 0.3 to 2.0%,
N: 0.0010 to 0.0050%,
Co: 0.0010 to 0.010%,
Ti: 0.0030% or less,
Nb: 0.0030% or less, and
O: 0.0050% or less,
with the balance being composed of Fe and unavoidable impurities;
a cold rolling step of, after annealing the hot-rolled sheet, or without annealing the hot-rolled sheet, cold-rolling the hot-rolled sheet once, or twice or more with intermediate annealing in between, into a cold-rolled sheet;
an electrolytic degreasing treatment step of subjecting the cold-rolled sheet to electrolytic degreasing treatment; and
a finishing annealing step of performing finishing annealing on the cold-rolled sheet having been subjected to the electrolytic degreasing treatment, wherein:
the electrolytic degreasing treatment is performed at a charge density of 3 to 12 (C/dm²), using an alkali liquid having a concentration of 1 to 10% and a liquid temperature of 30 to 120 °C, for 1 to 15 seconds; and
a dew point in the finishing annealing is −70 to −10 °C.

6. The production method of a non-oriented electrical steel sheet according to claim 5, wherein
the steel slab further contains, in addition to the ingredient composition, an ingredient or ingredients of one or more groups among the following groups A to C, in mass %:
group A: one type or two types selected from Sn: 0.005 to 0.20% and Sb: 0.005 to 0.20%,
group B: one type or two or more types selected from Cu, Ni, and Cr: 0.03 to 1.0% in total, and
group C: one type or two or more types selected from Ca, Mg, and REM: 0.0005 to 0.020% in total.

7. The production method of a non-oriented electrical steel sheet according to claim 5, wherein
the steel sheet further contains, in addition to the ingredient composition, an ingredient or ingredients of one or more groups among the following groups D to G, in mass %:
group D: one type or two or more types selected from Ge and Ga: 0.0005 to 0.01% in total,
group E: Zn: 0.001 to 0.05%,
group F: one type or two or more types selected from Mo, As, and W: 0.001 to 0.05% in total, and
group G: one type or two or more types selected from B, Pb, and V: 0.0001 to 0.01% in total.

8. The production method of a non-oriented electrical steel sheet according to claim 5, wherein
the alkali liquid in the electrolytic degreasing treatment is one type selected from sodium hydroxide, potassium hydroxide, calcium hydroxide, and sodium orthosilicate.

9. The non-oriented electrical steel sheet according to claim 2, wherein
the steel sheet further contains, in addition to the ingredient composition, an ingredient or ingredients of one or more groups among the following groups A to C, in mass %:
group A: one type or two types selected from Sn: 0.005 to 0.20% and Sb: 0.005 to 0.20%,
group B: one type or two or more types selected from Cu, Ni, and Cr: 0.03 to 1.0% in total, and
group C: one type or two or more types selected from Ca, Mg, and REM: 0.0005 to 0.020% in total.

10. The non-oriented electrical steel sheet according to claim 2, wherein the steel sheet further contains, in addition to the ingredient composition, an ingredient or ingredients of one or more groups among the following groups D to G, in mass %:
group D: one type or two types selected from Ge and Ga: 0.0005 to 0.01% in total,
group E: Zn: 0.001 to 0.05%,
group F: one type or two or more types selected from Mo, As, and W: 0.001 to 0.05% in total, and
group G: one type or two or more types selected from B, Pb, and V: 0.0001 to 0.01% in total.

11. The non-oriented electrical steel sheet according to claim 3, wherein the steel sheet further contains, in addition to the ingredient composition, an ingredient or ingredients of one or more groups among the following groups D to G, in mass %:
group D: one type or two types selected from Ge and Ga: 0.0005 to 0.01% in total,
group E: Zn: 0.001 to 0.05%,
group F: one type or two or more types selected from Mo, As, and W: 0.001 to 0.05% in total, and
group G: one type or two or more types selected from B, Pb, and V: 0.0001 to 0.01% in total.

12. The non-oriented electrical steel sheet according to claim 9, wherein the steel sheet further contains, in addition to the ingredient composition, an ingredient or ingredients of one or more groups among the following groups D to G, in mass %:
group D: one type or two types selected from Ge and Ga: 0.0005 to 0.01% in total,
group E: Zn: 0.001 to 0.05%,
group F: one type or two or more types selected from Mo, As, and W: 0.001 to 0.05% in total, and
group G: one type or two or more types selected from B, Pb, and V: 0.0001 to 0.01% in total.

13. The production method of a non-oriented electrical steel sheet according to claim 6, wherein
the steel sheet further contains, in addition to the ingredient composition, an ingredient or ingredients of one or more groups among the following groups D to G, in mass %:
group D: one type or two or more types selected from Ge and Ga: 0.0005 to 0.01% in total,
group E: Zn: 0.001 to 0.05%,
group F: one type or two or more types selected from Mo, As, and W: 0.001 to 0.05% in total, and
group G: one type or two or more types selected from B, Pb, and V: 0.0001 to 0.01% in total.

14. The production method of a non-oriented electrical steel sheet according to claim 6, wherein the alkali liquid in the electrolytic degreasing treatment is one type selected from sodium hydroxide, potassium hydroxide, calcium hydroxide, and sodium orthosilicate.

15. The production method of a non-oriented electrical steel sheet according to claim 7, wherein the alkali liquid in the electrolytic degreasing treatment is one type selected from sodium hydroxide, potassium hydroxide, calcium hydroxide, and sodium orthosilicate.

16. The production method of a non-oriented electrical steel sheet according to claim 13, wherein the alkali liquid in the electrolytic degreasing treatment is one type selected from sodium hydroxide, potassium hydroxide, calcium hydroxide, and sodium orthosilicate.
